(19) United States
(12) Patent Application Publication
(10) Pub. No.: US 2025/0388496 A1
(43) Pub. Date: Dec. 25, 2025

(54) ENHANCED SYSTEM, STRUCTURE AND METHOD FOR REMOVAL OF PFAS FROM AQUEOUS MATERIALS

(71) Applicants: Randall Moore, Powell, TN (US); Kevin Jackson, Knoxville, TN (US)

(72) Inventors: Randall Moore, Powell, TN (US); Kevin Jackson, Knoxville, TN (US)

(21) Appl. No.: 19/309,787

(22) Filed: Aug. 26, 2025

Related U.S. Application Data
(63) Continuation-in-part of application No. 18/948,238, filed on Nov. 14, 2024.
(63) Continuation-in-part of application No. 18/946,159, filed on Nov. 13, 2024.
(63) Continuation-in-part of application No. 17/237,040, filed on Apr. 21, 2021.
Application No. 17/237,040 is a continuation-in-part of application No. 17/087,728, filed on Nov. 3, 2020, now Pat. No. 12,172,909.

(51) Int. Cl. C02F 1/48; C02F 1/42; C02F 101/36

(52) U.S. Cl. CPC C02F 1/48; C02F 1/42; C02F 2001/422; C02F 2001/425; C02F 2101/36

(57) ABSTRACT

A system and method for the removal of poly- and/or perfluoroalkyl fluorinated materials contaminants from an aqueous mass uses a system which includes:
a) a first chamber for holding the aqueous mass containing a detectable amount of poly- and/or perfluoroalkyl fluorinated materials;
b) an anode and a cathode in electronic connection with the aqueous mass in the first chamber; and
c) an anionic semipermeable membrane or porous structure between the aqueous mass and the anode.

The anionic semipermeable membrane comprises at least 0.0001% by total weight of the anionic semipermeable membrane of a cationic compound adhered to the anionic semipermeable membrane.

### RELATED APPLICATIONS DATA

This application claims priority under 37 C.F.R. 1.120 as continuation-in-part of U.S. patent application Ser. No. 19/948,238, filed 13 Nov. 2024 (and titled ENHANCED SYSTEM AND METHOD FOR REMOVAL OF PFAS FROM AQUEOUS MATERIALS), and U.S. patent application Ser. No. 18/946,159, filed 13 Nov. 2024 (and titled ENHANCED SYSTEM AND METHOD FOR REMOVAL OF PFAS FROM AQUEOUS MATERIALS) which are each a Continuation-in-Part of U.S. patent application Ser. No. 17/237,040, filed 21 Apr. 2021 and titled “APPARATUS AND METHOD FOR MEDIATION OF PFAS CONTAMINATION IN AN ENVIRONMENT which in turn is a Continuation-in-Part of U.S. patent application Ser. No. 17/087,728, filed 3 Nov. 2020 and titled “APPARATUS AND METHOD FOR MEDIATION OF PFAS CONTAMINATION IN AN ENVIRONMENT.” Those Applications are incorporated herein in their entirety by reference.

### BACKGROUND OF THE INVENTION

### 1. Field of the Invention

The present invention relates to the mediation of contaminated aqueous materials containing poly- and/or perfluoroalkyl fluorinated (also referred to as highly-fluorinated alkyl) materials as contaminants.

### 2. Background of the Art

Perfluoroalkyl and polyfluoroalkyl substances (PFAS) are a class of man-made compounds that have been used to manufacture consumer products and industrial chemicals, including, inter alia, aqueous film forming foams (AFFFs), stain resistant treatments, motor coolant, anti-slip surfaces, fire-suppressing foams and the like. AFFFs have been the product of choice for firefighting at military and municipal fire training sites around the world. AFFFs have also been used extensively at oil and gas refineries for both fire training and firefighting exercises. AFFFs work by blanketing spilled oil/fuel, cooling the surface, and preventing re-ignition, PFAS in AFFFs have contaminated the groundwater at many of these sites and refineries, including more than 100 U.S. Air Force sites.

PFAS may be used as surface treatment/coatings in consumer products such as carpets, upholstery, stain resistant apparel, cookware, paper, packaging, and the like, and may also be found in chemicals used for chemical plating, electrolytes, lubricants, and the like, which may eventually end up in the water supply.

PFAS are bio-accumulative in wildlife and humans because they typically remain in the body for extended periods of time. Laboratory PFAS exposure studies on animals have shown problems with growth and development, reproduction, and liver damage. In 2016, the U.S. Environmental Protection Agency (EPA) issued the following health advisories (HAs) for perfluorooctanesulfonic acid (PFOS) and perfitioroortanoic acid (PFOA): 0.07 μg/L for both the individual constituents and the sum of PFOS and PFOA concentrations, respectively. Additionally, PFAS are highly water soluble in water, result in large, dilute plumes, and have a low volatility.

PFAS are very difficult to treat largely because they are extremely stable compounds which include carbon-fluorine bonds. Carbon fluorine bonds are the strongest known bonds in nature and are highly resistant to breakdown. With each year, more diseases caused by PFAS are being reported.

### SUMMARY OF THE INVENTION

A system removes poly- and/or perfluoroalkyl fluorinated material contaminants from a contaminated aqueous mass. The system includes:
a) a first chamber for holding the aqueous mass containing a detectable amount of poly- and/or perfluoroalkyl fluorinated materials; b) an anode and a cathode in electronic connection with the aqueous mass in the first chamber; c) an anionic poly- and/or perfluoroalkyl fluorinated material contaminant-retaining sheet between the aqueous mass and the anode; and d) a cationic contaminant material retaining sheet between the aqueous mass and the cathode, the system is typically within a structural housing to contain components. Specific physical features can be used on at least c) to assure proper alignment of layers between the anode and the cathode. The anionic poly- and/or perfluoroalkyl fluorinated material contaminant-retaining sheet has a retention-enhancing coating on it.

### BRIEF DESCRIPTION OF THE FIGURES

FIG. 1 is a schematic of a cross-section of an AEC of the present technology.

FIG. 2 is a graphic representation of Total Current Required for PFOA Removal —Activity I.

FIG. 3 is a graphic representation of Total Current Required for PFOA Removal Activity I.

FIG. 4 is a graphic representation of Total Current Transfer Required to Achieve Fractional Salt Removal—Activity I.

FIG. 5 is a graphic representation of Total Current Transfer Required to Achieve Salt Mass Removal—Activity.

FIG. 6 is a graphic representation of Total PFOA and PFOS Removal as a Function of Salt Removal—Activity I.

FIG. 7 is a graphic representation of Total Current Required for PFOA Removal at 10 ppb Feed.

FIG. 8 is a graphic representation of Total Current Required for PFOA Removal at 10 ppb Feed.

FIG. 9 is a graphic representation of Total Current Required for PFOA and PFOS Removal at 10 ppb Feed.

FIG. 10 is a graphic representation of Total Current Required for PFOA Removal at 2 ppb Feed.

FIG. 11 is a graphic representation of Total Current Required for PFOS Removal at 2 ppb Feed.

FIG. 12 is a graphic representation of Total PFOA and PFOS Removal Versus Total Current at 2 and 10 ppb Feed.

FIG. 13 is a graphic representation of Total Current Required Total PFOS and PFOS Removal at 2 ppb Feed.

FIG. 14 is a graphic representation of Total Current Required to Achieve Salt Removal.

FIG. 15 is a graphic representation of Total PFOA and PFOS Removal Versus Salt Removal (20 ppb Total PFOA and PFOS).

FIG. 16 is a graphic representation of Total PFOA and PFOS Removal Versus Salt Removal (4 ppb Total PFOA and PFOS).

FIG. 17 is a graphic representation of Total Required Energy Per Mass PFAS Removal as a Function of Total PFAS Removal.

FIG. 18 is a graphic representation of AEC Operating Energy as a Function of Total Current.

FIG. 19 is a graphic representation of Activity I Average Run Cell Resistance as a Function of Average Feed Conductivity.

FIG. 20 is a graphic representation of Activity I Average Run Cell Resistance as a Function of Average Feed Conductivity.

FIG. 21 is a graphic representation of Activity I Average Run Cell Resistance as a Function of Average Feed Conductivity.

FIG. 22 is a graphic representation of Salt Removal Versus Total Power—Activity I.

FIG. 23 is a graphic representation of Effect of Electrode Spacing on AEC Module Resistance.

FIG. 24 is a graphic representation of Impact of AEM Final Conductivity on AEC Module Average Electrical Resistance—Activity I.

FIG. 25 is a graphic representation of Impact of Total Current on AEM and CEM Chamber Conductivity.

FIG. 26 is a graphic representation of Comparison of Total Current Requirement of Test 2-5 and 2-9.

FIG. 27 is a graphic representation of Comparison of FKS-50® membrane and Nafion® 117 membrane CEM Performance.

FIG. 28 is a graphic representation of Energy and Voltage as a Function of Feed Residence Time.

FIG. 29 is a graphic representation of Effect of Temperature on Salt Removal.

FIG. 30 is a graphic representation of Effect of Temperature on Total PFOA and PFOS Removal.

FIG. 31 is a graphic representation of Power Costs Based on Salt Rejection —Batch Testing.

FIG. 32 is a graphic representation of Power Costs Based on PFAS Removal—Flow Through Testing.

FIG. 33 is a graphic representation of Power Costs Based on PFAS Removal—Flow Through Testing.

FIG. 34 is a graphic representation of Power Costs Based on PFAS Removal—Flow Through Testing.

FIG. 35 is a representation of the internal operation of the systems of the present invention with a multicell system shown with a contaminated aqueous feed

FIG. 36 is a representation of an exploded view of a cell with markings distinguishing respective anodic semipermeable membranes and cathodic semipermeable membranes.

FIG. 36A is a representation of an exploded view of a cell with excentric connection points in the cell to assure single position alignment of the cell within a housing.

### DETAILED DESCRIPTION OF THE INVENTION

A system removes poly- and/or perfluoroalkyl fluorinated material contaminants from a contaminated aqueous mass. The system includes:
a) a first chamber for holding the aqueous mass containing a detectable amount of poly- and/or perfluoroalkyl fluorinated materials; b) an anode and a cathode in electronic connection with the aqueous mass in the first chamber; c) an anionic poly- and/or perfluoroalkyl fluorinated material contaminant retaining sheet (ACR) between the aqueous mass and the anode; and d) a cationic contaminant material retaining sheet (CCR) between the aqueous mass and the cathode, the system is typically within a structural housing to contain components. Specific physical features can be used on at least c) to assure proper alignment of layers between the anode and the cathode. An essentially chemically inert separator should be used between the ACR and CCR.

The anionic poly- and/or perfluoroalkyl fluorinated material contaminant retaining sheet comprises at least 0.0001% by total weight of the anionic poly- and/or perfluoroalkyl fluorinated material contaminant retaining sheet of a cationic material or a proteinaceous material adhered to the anionic semipermeable membrane. There is typically a spacer within the first chamber (through which the aqueous mass flows. The spacer is sufficiently open to allow relatively free passage of fluid (e.g., the contaminated aqueous fluid) through the interior volume of the spacer which may be filamentary, fabric, molded or extruded. It may be rigid, semi-rigid, or flexible, and it must be sufficiently sturdy as to endure 200 hours of continuous water flow through its interior at a volumetric flowrate of 1.0 g/m. The spacer may be a mesh or frame having a thickness of from 30μ to 5 mm between the anionic poly- and/or perfluoroalkyl fluorinated material contaminant retaining sheet and the cationic poly- and/or perfluoroalkyl fluorinated material contaminant retaining sheet. The cationic material is adhered to the anionic semipermeable membrane and may be (by non-limiting example) a compound having a cation selected from the group consisting of quaternary and ammonium cations, sulfonium cations, phosphonium cations, iodonium cations, and boronium cations. The anionic poly- and/or perfluoroalkyl fluorinated material contaminant retaining sheet may have at least 0.0001% or at least 0.0005% by total weight of the anionic poly- and/or perfluoroalkyl fluorinated material contaminant retaining sheet of a cationic quaternary ammonium compound adhered to the anionic poly- and/or perfluoroalkyl fluorinated material contaminant retaining sheet. The cationic material may be a polymer adhered to the anionic poly- and/or perfluoroalkyl fluorinated material contaminant retaining sheet and may be a quaternary ammonium polymer. The spacer may have a thickness between about 20 μm to 5 mm, preferably between 30 μm and 2 mm. The anionic poly- and/or perfluoroalkyl fluorinated material contaminant-retaining sheet has a retention-enhancing coating on it, such as the above-identified cationic materials.

The total thickness of the at least combined elements between the cathode and anode (should be at least 90 μm and less than 20 mm for efficiency. Smaller thicknesses will restrict volume throughput, even though the rate of extraction might be higher locally within these three layers. Larger thicknesses will have greater rates of throughput, but local retention efficiency decreases, and then the likelihood of serially connected systems being needed increases. With thinner systems of these sets of ACR, spacer and CCR, parallel devices can be conveniently used to increase overall flow rates and provide increased efficiency along the flow path. With a single anode and cathode driving adsorption on multiple sets of ACRs and CCRs, thickness of up to 100 mm may be used. The system may have cationic materials (e.g., a proteinaceous material present) on the anionic poly- and/or perfluoroalkyl fluorinated material retaining sheet.

A method for extracting poly- and/or perfluoroalkyl fluorinated materials from a contaminated aqueous medium uses the system described above. The system of claim 1 within a housing with a feed liquid comprising an aqueous medium contaminated with measurable levels of poly- and/or perfluoroalkyl fluorinated materials within a chamber. A current is applied between the anode and cathode to attract the poly- and/or perfluoroalkyl fluorinated materials towards the anode and onto the anionic semipermeable membrane. The anionic poly- and/or perfluoroalkyl fluorinated material contaminant retaining sheet retains poly- and/or perfluoroalkyl fluorinated materials thereon and therein.

When installing replacement parts, and even in the initial manual construction of the device, there is the distinct possibility of placing individual layers, particularly the anionic and cationic semipermeable membranes, in the wrong order. This would destroy the functionality of the system. To prevent this, at least one of the membranes should have some physical and/or visual distinguishing characteristic providing clear indication of the order of the layers. At a minimum, a visual marking on at least one of the membranes may be present so that one membrane is visually distinguished from the other. Any marking, such as a waterproof color marking on an edge or face of a membrane, an embossed or stamped marking, excentric alignment of bolt through-holes, or an edge indentation or notch fitted to the excentric alignment of bolts, or a pin or post in the frame should be used. By excentric, it is meant that the distribution of holes, notches or indentations may be aligned within the frame in only a single orientation, no matter how it is turned or rotated. The system should therefore have these position-sensitive markings, holes, color markings, indentations or cuts on one or more of at least the three layers comprising the spacer, the anionic poly- and/or perfluoroalkyl fluorinated material contaminant retaining sheet, and the cationic retaining sheet such that the three layers can be positioned within a housing with only one alignment of the three layers within the housing when the position-sensitive markings, holes, color markings, indentations or cuts are visually and/or physically aligned. The at least three layers include the spacer, the anionic poly- and/or perfluoroalkyl fluorinated material contaminant retaining sheet, and the cationic retaining sheet. These can be secured together by mechanical connectors (including by way of non-limiting examples, snaps, bolts, screws, nails, fabric fasteners, and the like) or chemical bonding (adhesive, fusion, and the like) and the position-sensitive markings, holes, color markings, indentations or cuts are visually and/or physically aligned across the three layers.

The replacement combinations of layers may be provided in multiple types of sets, including, but not limited to mutually secured replacement sets of ACR-Spacer-CCR, or ACR-Spacer-CCR-electrode, or electrode-ACR-Spacer-CCR-electrode replacement units. These combination replacement units (with multiple layers) should be provided with the above-described types of visual and/or physical structures matching compatible physical structuring in the housing to assure proper alignment of layers within the housing. E.g., the notches in the replacement structure must mate with a protrusion in the housing where the replacement layers are provided.

The current technology advance includes a system and method of using that system for the removal of poly- and/or perfluoroalkyl fluorinated (also referred to as highly-fluorinated alkyl) materials as contaminants from an aqueous mass. The system may generally include:
a. a first chamber for holding the aqueous mass containing a detectable amount of poly- and/or perfluoroalkyl fluorinated materials;
b. an anode and a cathode in electronic connection with the aqueous mass in the first chamber; and
c. an anionic poly- and/or perfluoroalkyl fluorinated material attractant and/or a semipermeable membrane or porous support for the poly- and/or perfluoroalkyl fluorinated material attractant between the aqueous mass and the anode.

The anionic semipermeable membrane typically includes at least the above-mentioned 0.0001% or at least 0.0005% by total weight of the anionic semipermeable membrane of a cationic compound or protein compound adhered to the anionic semipermeable membrane (also described as an “ASM”). The adherence of the cationic material or protein to the ASM may be as an adhered coating, a bonded (direct or with intermediate priming layer or surface) coating, a continuous coating, a discontinuous coating, sputter deposited layer, embedded particulate layer (continuous or discontinuous), and intermeshed fibrous materials.

The system typically will have a relatively stable (that is not chemically reactive spacer or mesh within the system) and a second aqueous mass or volume adjacent the anode and adjacent the anionic semipermeable membrane. A thin layer of water (with or without any other solubles) is sufficient at the surface of the electrode (against the electrode) and wetting/penetrating the semipermeable membrane. This second (or later third) aqueous mass acts to complete the biasing circuit between the anode and cathode across the intermediate volumes and layers.

The system may have the cationic material on the ACR as a compound (including salts, blends, films, polymers, discontinuous coatings, etc.) having a cation preferably selected from the group consisting of quaternary ammonium cations, sulfonium cations, phosphonium cations, iodonium cations, and boronium cations. Other cationic materials may be used, but these are the most common and simplest to use in the practice of the present invention.

The system also may have the cationic material present as at least 0.0001% or at least 0.0005% or at least 0.001% by total weight of the anionic semipermeable membrane or porous support (of course, measured as not including the weight of the cationic material) of a cationic compound adhered to the anionic semipermeable membrane or porous support.

The systems of this technology are most easily constructed wherein the cationic material comprises a polymer. The preferred polymers, because of their broad commercial availability and well-known properties system are quaternary ammonium polymers. The system is best functional when the anionic semipermeable membrane has a thickness of at least 20 μm and preferably between 30 μm and 900 μm. (As later described, the porous support or separator may be or may have to be thicker, such as from 50 μm or 2 mm or more). Thinner membranes tend to be too fragile, although functional, and thicker membranes offer no significant further PFAS removal improvement, as much of the adherence of the PFAS takes place in the upper portions of the membrane (towards the first chamber), and seldom much beyond 400 μm. (As the porous materials are thicker, with generally larger pores and a greater flow rate through them, there tends to be more internal adsorption of PFAS).

The systems may also use the anionic semipermeable membrane with a thickness between 100 μm and 700 μm. The system may also use a cationic semipermeable membrane between the contaminated aqueous mass volume (e.g., within the spacer or mesh) and the cathode. The system preferably may also include a cationic semipermeable membrane between the aqueous mass and the cathode, and further wherein there is a third aqueous mass adjacent the cathode and adjacent the cathodic semipermeable membrane. The cationic semipermeable membrane also may have a thickness between 30 μm and 900 μm.

The systems may use a spacer (as further described herein) within the first chamber to prevent the anodic semipermeable membrane and the cationic semipermeable membrane from collapsing into the first chamber.

A new aspect of the present technology is the discovery of the use of added amounts, discontinuous coatings and even continuous coatings of cationic materials, particularly cationic polymers or cationic coatings on and/or in the anionic semipermeable membrane (hereinafter, “ASM”). The addition of these cationic materials has been found to increase the strength of retention of anionic PFAS materials on and in the ASM. Amounts as small as at least 0.0001% or at least 0.0005% by weight of cationic materials in the ASM material produce significant and measurable increases in PFAS retention. The only limit on higher amounts of cationic materials is avoiding such clogging of the pores that PFAS cannot move under the biasing current into the pores. Depending on pore frequency and size and total volume, the weight range of cationic materials may be from 0.0001% or 0.0005%-10% by weight of the ASM total weight (not including cationic materials). More typically, the range will be from 0.001% to 5%, 0.001 to 3%, 0.005% to 3%, or 0.075% to 2%. Any cationic compound/polymer may be used if the cationic material if at least 50% of the cationic material adheres to the ASM for at least 10 hours in deionized water at 70° F. flowing at 1 cm/minute over the coated ASM surface. The pore size in ASMs can vary significantly depending upon the materials targeted for attraction. In osmosis systems and ultrafiltration systems, the pore size may be as small as 0.1 nm, so that is a minimum size for any range of ASMs in the practice of the present technology. More likely, where there are higher molecular weight PFAS (e.g., not only CF₄ or CF₃COOH size molecules), larger pore sizes, and larger minimum pore sizes are desirable, such as at least 2 nm, at least, 5 nm, at least 25 nm, at least 50 nm, at least 100 nm, and even at least 200 nm. (as background information, cf https://Iink.springer.com/chapter/10.1007/978-3-540-73994-4_5 as K. C. Khulbe, C. K. Feng, T. Matsura, Springer Laboratories, Synthetic Polymer Membranes, pp. 101-139). The largest pores sizes generally found are about 500 nm, 2000 nm (e.g., 2 μm), up to a top commercial system of about 10 μm, 20 μm, 50 μm or 100 μm (Khulbe, supra). The larger the pore size, there is likely greater throughput of contaminated liquids, but with an increasing possibility that some nano-size nonionic particles may pass entirely through the ASM. General ranges may be selected from within 1-1000 nm, 1-700 nm, 2-500 nm and the like, with any selected range using any of the above lowest pore sizes up to a combination with the largest pore sizes listed above.

The cationic materials useful as the additive to the ASMs is any solid-forming or solid material having a positive charge that can persist on the ASM in room temperature distilled water without more than 50% dissolving in light agitation for at least 10 hours. The most common materials used as the cationic additive (partial or continuous coating, particulate, fibrous, or deposited content on the ASM) are multimeric (at least dimeric, more typically polymeric) molecules having a definitive positive charge on a contained (within the multimeric material) positively charged group. These materials are most typically chains (including chains with ring groups) having dependent cationic groups such as quaternary amines, sulfonium groups, phosphonium groups, boronium groups, iodonium groups (and possibly other halonium groups) as known in the art. By having the positively charged groups as pendant groups, they tend to be more accessible to attract PFAS and retain them in an ionic bond.

Cationic polymers are a family of polymers that carry a positive charge due to the presence of cations, which are positively charged ions. This positive disposition makes them sociable with negatively charged substances, allowing them to form strong bonds.

### Chemical Structure and Properties

Cationic polymers are a family of polymers positively charged at certain pH levels (e.g., there are always some positively charges present, but the concentration/frequency of positive charges varies with the pH.

The chemical structure of these polymers includes a backbone with the attached quaternary groups. In this discussion, the most common cationic/positively charged group, called quaternary ammonium (or quaternary amine) groups will be generally discussed. As later evidenced herein, there are numerous alternative groups, not all of which have been specifically identified. These hold the positive charge that makes the polymer cationic.

This positive charge is what gives these polymers their general PFAS attractive ability. For instance, in water treatment, they act like attractants, clumping together unwanted molecules so that they can be more easily removed from the scene. They work efficiently and fast, making them ideal in situations where time is of the essence.

As quaternary (cationic) materials tend to have significant solubility in water, in the preferred practices of the present invention, they should form stable films to make them persistent as an active coating.

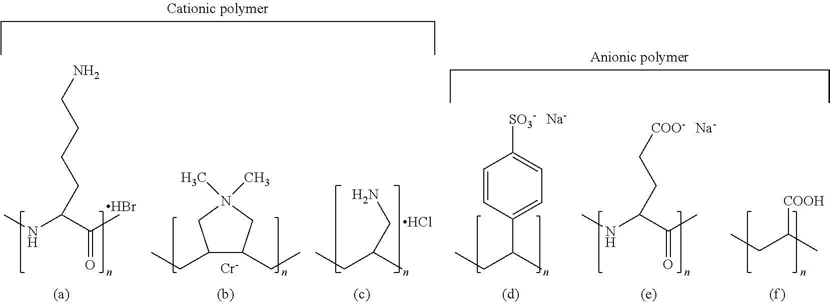

Examples of other cationic polymers are listed below.

SULFONIUM POLYMERS, CONTAINING S+R¹R²R³R⁴ groups (where R are hydrogen, linear or cyclic alkyl, alkylene, aryl, or other organic groups).

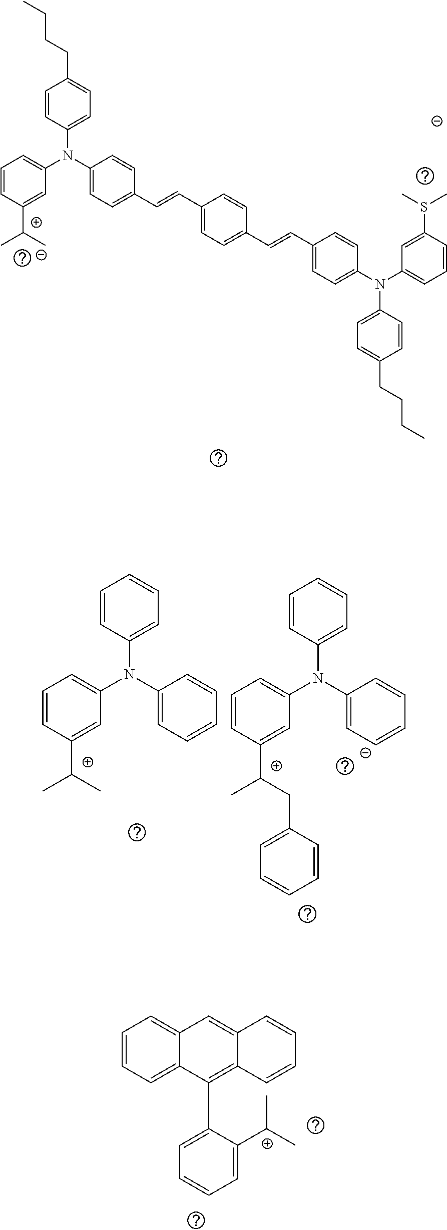

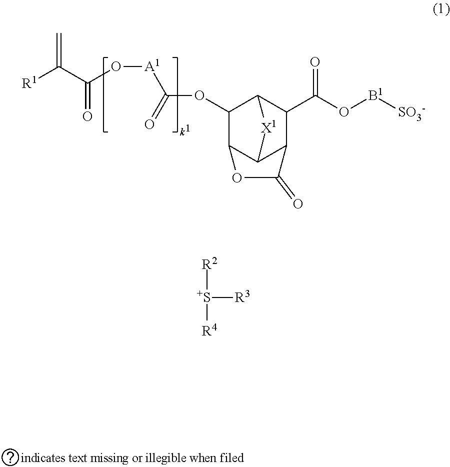

The method and structures may have the anionic semipermeable membrane abut the anode and maintains a second aqueous liquid between the anode and the anionic semipermeable membrane. The method may also have the second aqueous liquid be substantially free of poly- and/or perfluoroalkyl fluorinated materials. The method may also have a cationic semipermeable membrane abut the cathode and maintain a third aqueous liquid between the cathode and the cationic semipermeable membrane. The cathodic membrane is often used instinctively in the design of chambers, but is not essential for the remediation of aqueous masses having poly- or perfluoroalkyl fluorinated materials which are overwhelmingly anionic. However, to obtain maximum extraction of poly- or perfluoroalkyl fluorinated materials, the cationic semipermeable membrane is typically employed.

It was stated above that the anionic semipermeable membrane comprises at least 0.0005% by total weight of the anionic semipermeable membrane of a cationic compound adhered to the anionic semipermeable membrane. There are a number of considerations about the amount of PFAS retaining composition (PRC) on the anionic semipermeable membrane that is beneficial. Essentially, any measurable amount added increases the effective retention of PFAS on the ASM. The only upper limit on amounts of the PRC would be such an amount that excessively (more than 1%) or substantially fills (more than 15% or more than 25%) all or most more than 50%) of the pores in the ASM. The PRC may coat or line the pores, but should not close off accessibility into the pores. Additionally, the presence of the PRCs is most effective on the side of the ASM facing away from the anode (the distal side with respect to the anode). The efficiency of retention is so great, and the rate of entry of aqueous media into the pores is so relatively slow that the most rapid majority of retention occurs within the distal at least 10% and up to about 25% of the ASM, within the distal 50% of the ASM, and clearly within the distal 75% of the ASM. It is therefore optional to have the majority of the PRC within the distal 75%, 50% and even 25% of the distal volume of the ASM, even though it might be easier from a manufacturing standpoint to have the PRC essentially uniformly distributed throughout the ASM. The remaining thickness of the ASM without PRC on its surface tends to primarily add structural strength to the ASM. To that end, an ASM at the thinnest edge of the range of thicknesses allowed (30 μm, or even less at 20 μm) can be used if the proximal face of the ASM closest to the anode has a chemically inactive (to the environment) support layer abutting or bonded to that proximal face.

Because the retention is an essentially surface phenomenon, in that the PFAS is not merely absorbed into the structure of the uncoated ASM, but primarily retained on its surface, any majority of the PRC additive should be on the surface of the ASM composition. The coating may be discontinuous, as it would be with the smaller proportions by weight or volume to that of the PRC, or approach a continuous coating over the surface of the still-open pores, without clogging the opening to the pores. Again, the emphasis should be on adding PRCs on a distal face of the ASM. Most one-sided coating processes (e.g., spin coating, blade coating, extrusion coating, spray coating, single side dip coating, sputter etching, etc.) would tend to distribute higher concentrations of PRC on one face/side of the ASM, which likely would be the distal side of the ASM. With only interior pore surfaces being the objective of the applied solid PRC material to the ASM, extremely small proportions of the PRC to the ASM may be used.

Amounts lower than the weight of the uncoated anionic semipermeable membrane comprising at least 0.0001% or at least 0.0005% by total weight of the anionic semipermeable membrane of a cationic compound adhered to the anionic semipermeable membrane will still show some improvement in PFAS retention. This is particularly true where the highest concentration of PRC is distributed more heavily on one side (the distal side) of the ASM. It is unlikely that the total amount of PRC would ever exceed about 15% or ever exceed 10% of the total weight of the untreated ASM when there is a one-sided coating technique because of the likelihood of forming a continuous film and access to the pores being blocked.

Proteins are generally defined as any of a class of nitrogenous organic compounds that have large molecules composed of one or more long chains of amino acids and are an essential part of all living organisms, especially as structural components of body tissues such as muscle, hair, etc., and as enzymes and antibodies.

Proteins are large biomolecules and macromolecules that comprise one or more long chains of amino acid residues. Proteins perform a vast array of functions within organisms, including catalyzing metabolic reactions, DNA replication, responding to stimuli, providing structure to cells and organisms, and transporting molecules from one location to another. Proteins differ from one another primarily in their sequence of amino acids, which is dictated by the nucleotide sequence of their genes, and which usually results in protein folding into a specific 3D structure that determines its activity.

A linear chain of amino acid residues is called a polypeptide. A protein contains at least one long polypeptide. Short polypeptides, containing less than 20-30 residues, are rarely considered to be proteins and are commonly called peptides. The individual amino acid residues are bonded together by peptide bonds and adjacent amino acid residues.

The sequence of amino acid residues in a protein is defined by the sequence of a gene, which is encoded in the genetic code. In general, the genetic code specifies 20 standard amino acids; but in certain organisms the genetic code can include selenocysteine and—in certain archaea—pyrrolysine. Shortly after or even during synthesis, the residues in a protein are often chemically modified by post-translational modification, which alters the physical and chemical properties, folding, stability, activity, and ultimately, the function of the proteins.

Some proteins have non-peptide groups attached, which can be called prosthetic groups or cofactors. Proteins can also work together to achieve a particular function, and they often associate to form stable protein complexes.

Like other biological macromolecules such as polysaccharides and nucleic acids, proteins are essential parts of organisms and participate in virtually every process within cells. Many proteins are enzymes that catalyze biochemical reactions and are vital to metabolism. Proteins also have structural or mechanical functions, such as actin and myosin in muscle and the proteins in the cytoskeleton, which form a system of scaffolding that maintains cell shape.

Tertiary Structure: The tertiary structure of a protein is its three-dimensional conformation that is created when the protein folds. Hydrogen bonds stabilize the folding occurrences. Other intramolecular bonds that stabilize the folding processes include hydrophobic interactions; ionic bonds; and disulfide bridges. These bonds are formed between the R groups of amino acids. They contain the nonpolar parts of proteins which result in attractions and repulsions and become coiled up in one area, creating a very complex structure. The tertiary structure is the overall shape of the protein for which most are globular in shape, or fibrous—long and thin.

Quaternary Structure: A quaternary structure is formed when two or more tertiary polypeptide chains form a single or full protein. Certain proteins may have a non-polypeptide structure, thus belonging to a prosthetic group, while other proteins are conjugated. Here unique patterns are formed via hydrogen bonding.

### Structural Alternatives to Semipermeable Membranes as PFAS Collectors

In the entire background of literature on filtration, capture and retention of PFAS materials (also referred to in the art as ‘poly- and/or perfluoroalkyl fluorinated material contaminants’, it has been traditionally held that a semipermeable membrane was the only, or at least the most preferred element for the filtration, post-filtration capture by an anode and retention by an anode of PFAS contaminants. Except where the contaminants are being carried in association with a more macroscopic solid contaminant, physical filters, such as porous masses, would not be expected to offer even the potential for high percentages (e.g., at least 70%, at least 80%, at least 90%, or more than 95% up to 99%-100%) capture in a single pass through or adjacent to the porous mass.

It has been surprisingly found that a structural sheet of substantially any porous material, if activated (coated, continuously or discontinuously, by a PFAS enhanced-retention composition may be used to replace the more expensive semipermeable membrane. For example, a reticulated foam, porous sheet (e.g., with etched or otherwise provided pores through the sheet), fabrics (non-woven, woven, knitted, layered), cellulosic sheets, composites of cellulosic materials, ceramics, glasses, metals, and polymers (especially ethylenically-based polymers (polyethylene, polypropylene, polystyrene and copolymers thereof and therewith) nylons and other amido-group containing synthetics), carbon or graphite fibers, and any other sheets of film that has at least

In its definitions of air filtration terminology, ISO 29464 clearly distinguishes between the overall medium area and the effective medium area of an air filter. The overall filter area is the total area of filter medium contained in an air filter. The effective filter area, on the other hand, is defined as the medium area through which air passes, i.e., the area actually available for particulate filtration. Areas covered by adhesives, struts etc. do not count as effective filter area (See ISO 29464 (2011), p. 2). ISO 29461-1:2021 Annex A uses a similar definition. This standard for air intake filter testing for rotary machinery, and defines the effective filter area as the filter medium area available for particle separation (See ISO 29461 (2021) Annex A, p. 3).

The increased effective filter area has only minimal effect—on filtration performance at least —over the particle size spectrum considered (>0.3 m).

Cellulose acetate (CA) membranes have a very low binding affinity for most macromolecules and are especially recommended for applications requiring low protein binding, such as filtering culture media containing sera. However, both cellulose acetate and cellulose nitrate membranes are naturally hydrophobic and have small amounts (less than 1%) of non-toxic wetting agents added during manufacture to ensure proper wetting of the membrane. If desired, these agents can be easily removed prior to use by filtering a small amount of warm purified water through the membrane or filter unit. Surfactant-free cellulose acetate membranes with very low levels of extractables are available on some Corning® syringe filters. Cellulose nitrate (CN) membranes are recommended for filtering solutions where protein binding is not a concern. They are recommended for use in general laboratory applications such as buffer filtration. Corning's cellulose nitrate membranes are Triton™ X-100-free and noncytotoxic. Nylon membranes are naturally hydrophilic and are recommended for applications requiring very low extractables since they do not contain any wetting agents, detergents or surfactants. Their greater chemical resistance makes them better for filtering more aggressive solutions, such as alcohols and DMSO. However, like cellulose nitrate membranes, they may bind greater amounts of proteins and other macromolecules than do the cellulose acetate or PES membranes. They are recommended for filtering protein-free culture media. Polyethersulfone (PES) membranes are recommended for filtering cell culture media. PES has both very low protein binding and extractables. PES also demonstrates faster flow rates than cellulosic or nylon membranes. Regenerated cellulose (RC) membranes are hydrophilic and have very good chemical resistance to solvents, including DMSO. They are used to ultraclean and de-gas solvents and mobile phases used in HPLC applications. Polytetrafluorethylene (PTFE) membranes are naturally and permanently hydrophobic. The extreme chemical resistance of PTFE membranes makes them very useful for filtering solvents or other aggressive chemicals for which other membranes are unsuitable. Because of their hydrophobicity, PTFE membranes must be prewetted with a solvent, such as ethanol, before aqueous solutions can be filtered. Glass fiber filters are used as a depth filter for prefiltration of solutions. They have very high particle loading capacity and are ideal for prefiltering dirty solutions and difficult-to-filter biological fluids, such as sera. Corning Filter Housing Materials The filter housing materials, as well as the filter membrane must be compatible with the solutions being filters. Polystyrene (PS) is used in the filter funnels and storage bottles for the Corning plastic vacuum filters. This plastic polymer should only be used in filtering and storing nonaggressive aqueous solutions and biological fluids. Acrylic copolymer (AC) and Polyvinyl chloride (PVC) are used in some of the Corning syringe filter housings. These plastics should only be used in filtering nonaggressive aqueous solutions and biological fluids. Polypropylene (PP) is used in the Spin-X® centrifuge filters and some of the syringe and disc filter housings. This plastic polymer has very good resistance to many solvents. Filter Diameter/Dimension Effective Filter Expected and Description Area (cm2) Throughput (mL) 15 mm syringe/disc 1.7, 3-15-25 mm syringe/disc; 4.8, 10-50-26 mm syringe/disc; 5.3, 10-50-28 mm syringe/disc 6.2, 10-50 50 mm disc; 19.6 100-500-42 mm vacuum system/square; 13.6, 100-500-49.5 mm vacuum system/square; 19.6, 200-750-63 mm vacuum system/square; 33.2, 300-1500-79 mm vacuum system/square; 54.5 500-3000. These values assume an aqueous solution and a 0.2 micron membrane. Solutions containing sera or other proteinaceous materials will be at the lower end of the range. Use of prefilters may extend the throughput 50 to 100% above the values shown.

In general, the pore size of filter membranes is usually dictated by the requirements of the filter application rather than the desired flow rate. Larger pore membranes usually have both faster flow rates and greater capacity before pore clogging slows the flow. As expected, the initial flow rate (steep part of the curve) of the 0.45 μm filter was approximately twice that of the 0.22 μm filter, although its capacity or throughput prior to clogging (the area at the plateau) was only about 20% greater. In the practice of the present invention, solely for throughput requirements, pore sizes should be between 0.2 μm to 2.0 mm. The adsorption/absorption sheets should have an effective filter area of at least 0.10 to 50 m2 according to ISO 29464 (2011), p. 2.

The proportions of adherent agent to filter structural material should be at least 0.0005%, or at least 0.01% adherent agent, up to a maximum of 15% adherent agent per weight of the structural membrane material. Preferably, the proportions of adherent agent to structural material should be from 0.025% to 10%, or 0.25% to 5% on a weight:weight basis.

The adherent agent is inclusive (on the side of the PFAS mediation device closest to the anode) and is selected from the groups consisting of cationic materials (as defined herein) and proteinaceous materials on the surface of the porous structure.

Similarly, on the cathode side of the device, the same porous materials may be used, but with or without an anionic coating material thereon. The porous material on the cathodic side, because of its lower functionality in the practice of the invention, may be uncoated, or coated with the same proportions of an anionic coating material (as defined herein).

As some of these sheet materials have modest structural stability (e.g., especially the fabrics), it is likely that structural reinforcement elements may be embedded in or attached to the sheet materials, as with a rigid or semi-rigid mesh, frame, array of posts, and the like. The contaminant retaining sheets may have a thickness of from 20μ to 5 mm, or preferably 30μ to 2 mm, and more preferably from 50μ to 1 mm.

Commercial available filter materials, HEPA or not, may be used as the porous medium structure. These may be coated with the relevant anionic or cationic adsorbents or absorbents at a much lower cost than the semipermeable membranes. Many of these commercial materials are chemically stable (e.g., glass, ceramic, polypropylene, nylon, cellulose acetate, cellulose nitrate) and are suitable for use in the invention, with adsorbent enhancing compositions added thereto.

As defined herein, an “anionic PFAS (or also poly- and/or perfluoroalkyl fluorinated material contaminants) retaining sheet” is a porous sheet (within the limitations of porosity defined herein) having at least 5% of its exposed surface area fixed to an adsorbent enhancing composition selected from the group consisting of cationic materials (as defined herein) and proteinaceous materials (as well understood in the art and defined herein). Proetinaceous meaning any chemical material having a structural similarity to and functional activity to the properties of a protein.

The following features of the AEC of the present invention are thought to include at least the following:
It utilizes electrostatic separation for removal of PFAS chemical species that are not purely ionic in character, or that may be only slightly ionic.
Separation can be accomplished in a liquid with a relatively low total ionic strength (generally less than 500 mg/L TDS).
The low ionic strength of the initial feed liquid allows greater concentration in subsequent treatment stages as bulk ionic species are removed and concentrated along with the PFAS.
The concentrated PFAS are then more amenable to treatment using granular activated carbon (GAC) and advanced oxidation processes (AOP).
The AEC uses a combination of anion and cation exchange membranes to facilitate collection of the PFAS to minimize interaction of ionic species.
Collection/concentration focuses on anions (i.e., PFAS), and only chamber is used for initial collection of PFAS, although multiple chambers could be used.

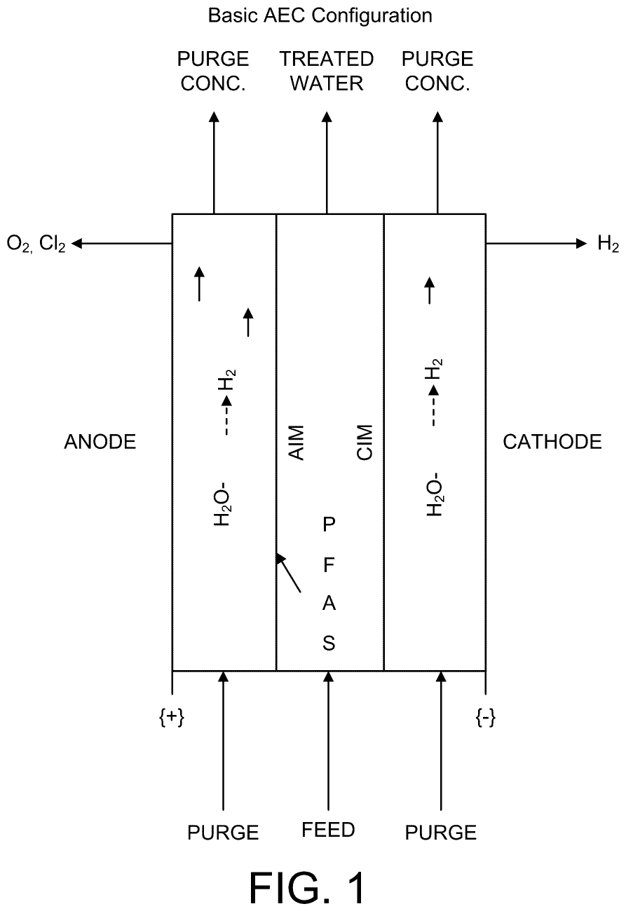

The AEC, in an explanation of its simplest form of use involves subjecting a water stream containing PFAS to opposing positive and negative electrically charged surfaces within a batch or flow-through module that includes ion exchange membranes to facilitate ion transfer and collection. The electrical charges are bisected by relatively thin (50 micron typically, better described above) thick sheets of anion/cation exchange membrane, and a suitable open volume on both the anode and cathode sides of the membranes to allow the water to pass. FIG. 1 shows a basic 3-chamber AEC. Water flow occurs through the center section (feed chamber) of the device, while the anode/cathode sides of the membrane have no or reduced induced water flow, to allow concentration of removed materials. The electrically charged PFAS molecules in the water are attracted toward and are transferred across the anion exchange membrane depending on their charge affinity.

The three chambers or volumes in the basic module include:
Feed Chamber—This is the center chamber of a 3-chamber AEC. In a batch system, PFAS contaminated water is placed in the feed chamber, and at the end of treatment is removed. In a flow-through system, the feed enters one side of the Feed Chamber and treated water exits the other side. The volume of the feed chamber can be dominated by the spacer, separator or mesh, with the contaminated feed liquid moving through the spacer or mass, and contaminants respectively driven towards the anode or cathode, into the ACR and CCR.
AEM Chamber (anodic electrode chamber)—This is the chamber (which may be dominated by the volume of or an anode-abutting volume of the ACR) that is between the AEM chamber and the Anode electrode. In a batch system, this chamber is initially filled with water. At the end of the treatment cycle this stream contains salt transferred from the Feed Chamber. Upon removal from the AEC this stream is typically recombined with the effluent from the CEM Chamber and combined with the treated stream.
CEM Chamber (cathodic electrode chamber)—This is the chamber (or volume within the CCR or adjacent the cathode within the CCR) that is between the CEM and the Cathode electrode. In a batch system, this chamber is or may be initially filled with water. At the end of the treatment cycle this stream, is recombined with the AEM stream to provide neutralization prior to recombination of this water with the treated water from the Feed Chamber.

The electrodes may require periodic cleaning by removing and/or reversing the polarity, while purging the contents that have accumulated within the collection area of the cell. In application, during this purge sequence, inlet flow may be diverted using continuous or automatic valving to a parallel AEC module or bank of modules.

Another embodiment of the system involves use of multiple individual AEM and CEM chambers operated in parallel. This allows, as with standard desalination technologies, the installation of multiple AEM/CEM cells within a single electrode bank.

Operation of two or more AEC modules in series allows the control of the operating voltage and thus limit the maximum current flux through an individual module. For example, an initial AEC module may operate at 60 VDC, while the second in series is operated at 200 VDC. In this example the first module would function to remove the bulk of PFAS, where the 2^{nd} in series would operate at a higher voltage to remove that last fractions of PFAS from the feed water stream.

It is envisioned that a full-scale unit would be controlled using a programmable logic controller (PLC) and human machine interface (HMI). Voltage control with electrical current limiting circuitry is envisioned to control the voltage supplied to each stage.

It is contemplated that this proprietary AEC technology will benefit target customers by producing a concentrated PFAS steam that can either be recycled or destroyed using other technologies such as AOP, or in conjunction with subsequent activated carbon (e.g. GAC) treatment of the concentrate. It has also been identified, as later disclosed, that PFAS may actually be chemically modified or decomposed by this process into harmless or less harmful non-PFAS species. It is believed that when AEC concentrate is treated using GAC, the pre-concentration can reduce both GAC bed size and bed replacement frequency.

Specifically, the higher PFAS concentration from AEC combined with lower treatment volume allows higher PFAS loadings on the GAC, as compared to a GAC system that treats the whole effluent. A GAC system is typically sized such that when the 1st bed outlet reaches half the treatment standard, that bed is replaced. At the 70 parts per trillion (ppt) EPA advisory level for total PFOA and PFOS, very little of the carbon's total capacity is used before it must be disposed or thermally regenerated at an offsite location. Treating concentrated PFAS using GAC has the potential to provide lower overall treatment cost, and a smaller overall physical footprint of the GAC treatment train because fewer or smaller GAC beds would be needed.

AEC may also produce a low volume concentrate stream containing the concentrated PFAS that could be treated directly using other technologies such as AOP. Recovery and recycling is also a potential option with the AEC. Similar synergies of treatment effectiveness occur with AOP, as AOP treatment is more cost effective at higher concentrations. These factors combined will enable affordable treatment of water for PFAS in applications and locales where PFAS treatment would otherwise be cost-prohibitive, thereby reducing the overall risk associated with PFAS exposure across the United States. Another benefit of the AEC use in industrial settings is that the treated feed stream will have a low conductivity, making it suitable for boiler feed makeup water.

### Overall AEC Dimensions and Configuration

The individual AEC assembly (module), as tested measured 3×8 inches [7.6×20.3 cm]. The thickness may vary over a wide range of from about 1.5 cm to 20 cm or more, depending on individual layer thicknesses. If multiple unites are stacked side by side, composite units may be thicker. The unit consisted of an outer polycarbonate support (5 mm), anode and cathode electrodes (Titanium), anode/cathode/feed chambers (5 mm) polycarbonate, and butyl rubber gasketing. Each chamber included three 2-inch×2-inch (5×5 cm) chambers that were interconnected by flow channels. The AEM and CEM were each “sandwiched” between two sheets of gasket material, and the semipermeable membranes were cut to fill the entire inner surface of the respective chambers.

For the Activity I (batch) testing, the AEC module was oriented horizontally, with vent holes in each chamber to allow the escape of gases. Between each chamber were 3 channels to connect the three chambers. For Activity II (flow-through) testing, the unit was oriented vertically, with a vent hole on the anode chamber. Entry and exit ports for liquid (and some gas) were located at the bottom and top sides of each chamber. Silicon tubing was used in Activity II testing.

### AEC Ion Exchange Membranes

The ion exchange membranes used in the testing included polymeric membranes such as Fumatech's Fumasep® FAS-50 (anion exchange membrane), Fumasep® FKS-50 (cation exchange membrane), and Chemour's Nafion® 117 (cation exchange membrane. Key specifications for these membranes are presented in Table 2-1. Fumasep® membranes are typically available in 20×20 cm (7.9×7.9 in), 52×52 cm (20.5×20.5 in), and 52×105 cm (20.5×41.3 in) with a maximum roll width of 165 cm (65 in). Nafion® membrane products are available in 12 in (4.7 cm) and 24 in (9.4 cm) widths, with a 50 meter (m), or 164 ft standard roll length.

TABLE 2-1
Ion Exchange Membrane Specifications

| Parameter | Units | FAS-50 | FKS-50 | Nafion-117 |
|---|---|---|---|---|
| Color | Specify | Amber | Clear | |
| Material | Specify | | | PFSA |
| Form delivered | Specify | Bromide | | H+ |
| Thickness | Um | 45-50 | 45-55 | 183 typ. |
| Reinforcement | Specify | None | None | |
| pH Range | Std. Units | 1-14 | 1-14 | |
| Storage | wt. % NaCl | 0.5-1.5 | 0.5 to 1.5 | |
| Exchange | meq/g | 1.6-1.8 | 1.3-1.4 | 0.95-1 |
| Capacity | | | | |
| Proton Transfer | umol/min- | 1000-3000 | NA | |
| Rate | cm² | | | |
| Selectivity | % | 92-97 | 98-99 | |
| Specific | Ohm/cm² | 0.4-0.8 | 0.9-1.9 | |
| Resistance | | | | |
| Typical current | mA/cm² | 10-20 | 10-20 | NA |
| flux | | | | |

PFSA - copolymer of tetrafluoroethylene and perfluorinated monomers containing sulfonic acid groups.

### Introduction to AEC Testing

Testing of the AEC was conducted in two operational modes that included batch testing (Activity I), and flow-through testing (Activity II). Parametric and other specific testing was conducted during each of these activities.

### AEC Configuration Modifications During Test Program

The primary testing variation during AEC testing was the addition of spacers in the center channel of the AEC. This modification was implemented during flow-through testing as a result of membrane damage caused by the elasticity of the membrane. The modification involved placing polypropylene mesh weave within the feed chamber to prevent the AEM and CEM from deforming into the feed chamber. During testing activities, the AEM showed the greatest potential for deformation. The mesh (defined so as to include either or both filamentary structures or with more substantive framework elements in a molded form of a frame) acts to provide a flow carrying volume for the contaminated fluid feed input, and it may redirect and recirculate the contaminated feed within the cell.

As an alternative or addition to the mesh, extruded lines of polymer (resistant to the chemical activity in the various liquids) can be placed over the membrane to stiffen the membrane against distortion or deformation and may also create a flow volume for the feed. Silicone polymers, fluorinated polymers, and polyethylene or polypropylene polymers are non-limiting examples of useful classes of polymers not likely to rapidly degrade in the harsh environment of the AEC liquids, but are not limiting examples thereof.

### Batch Testing Results (Activity I)

The first testing activity involved evaluation of AEC performance in batch mode. This test series is referred to as Activity I. Later flow-through testing is referenced as Activity II. Test run numbering convention is as follows: Activity—Test-Run. Using this convention 1-1-1 would be Activity I (Batch), Test 1, Run 1.

The Activity I batch testing apparatus was configured as described above.

### Batch Testing Protocol

Batch testing involved operating the AEC at a range of treatment times and voltages. Initial runs (10-01 through 1-0-25) were conducted to gain familiarity with the performance on the test feed solution, which consisted of sodium chloride mixed in deionized (DI) water at concentrations of 25, 250, and 500 mg/L. During testing the conductivity was measured using a conductivity meter as micro-Siemens per centimeter (uS/cm). Conductivity readings can be converted to mg/L NaCl by multiplying by a factor of 0.5.

Testing under the test matrix was conducted at three voltages, 10, 30 and 50 volts direct current (VDC), with test run durations of 5, 10, and 20 minutes. During one test of the Activity 1 suite a different CEM, Nafion® 117 membrane, was used in lieu of the Fumasep® FKS membrane that was used for all other tests.

### Modifications to Original Activity I Protocol

Key change from the original test protocol and key modifications are as follows:
Test 1-1-7 through 1-1-9 were not conducted. These runs were to be conducted without the CEM. When the first test run was conducted at this condition, the AEC failed to reduce feed chamber conductivity, and the membranes were damaged. Subsequent tests in this series were abandoned.
A test [test 1-10-(1-3)] was added to evaluate the impact of adding exfoliated graphite to the side chambers to assess the impact on salt removal and AEC overall resistance.
A test [Test 1-11-(1-3)] was added to evaluate the impact of side chamber conductivity on performance relative to salt removal.

### Batch Testing Results

Results from the initial batch testing are presented for both PFAS removal and salt removal are provided in the text below.

### PFAS Removal Results

PFAS operational and analytical results from the Activity 1 AEC batch testing are presented in Table 3-1. This table does not include testing where PFAS were not sampled and analyzed. Other tests as described further below were conducted to evaluate specific operating aspects on performance characteristics. A table presenting all test results is provided below. Tests 1-1-1 through 1-3-9 were all conducted with the same electrode spacing and using the same membranes (FumaSep® membrane).

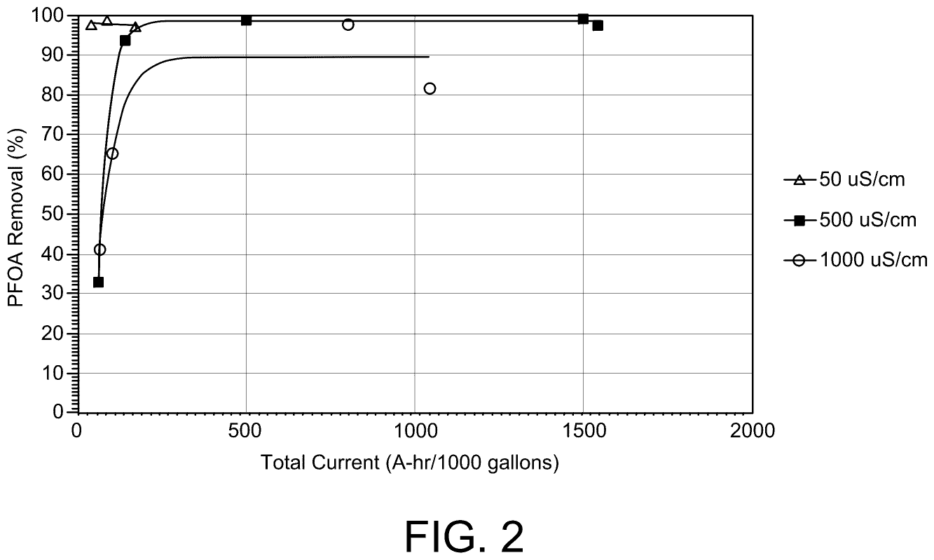

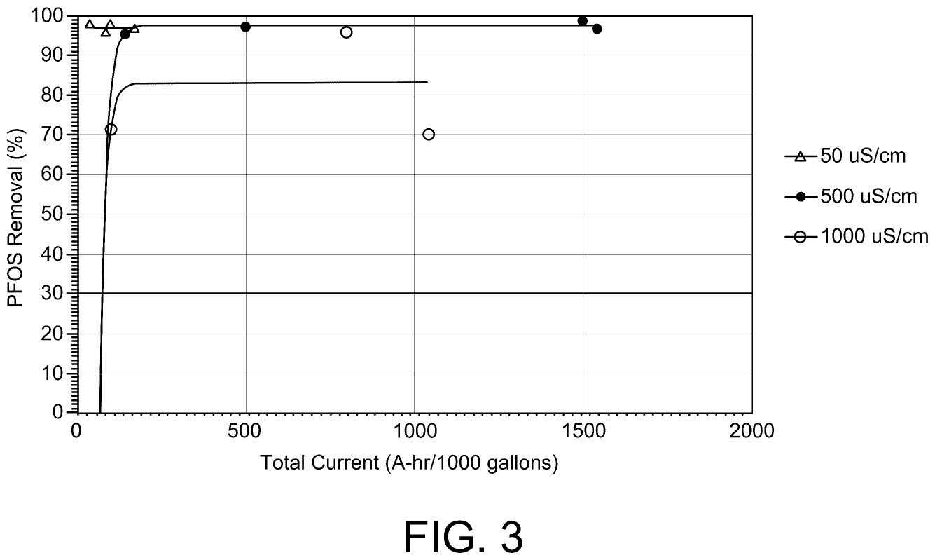

Test results showed effective removal of both PFOA and PFOS at total applied current above about 200 A-hr.1000 gallons treated, with feed concentrations being reduced from 100 ppb each PFOA/PFOS to less than 2 ppb. FIG. 2 provides a plot of percent PFOA removal as a function of applied current, and FIG. 3 provides the same plot for PFOS. Both plots show a consistent linear relationship between applied current and PFAS removal up to around 200 milliamps (mA), where the percent removal abruptly flattens with additional total current application. Additionally, percent removal for both PFOA and PFOS are similar for the same total current input. The results also show that at lower salt concentrations, lower total current was required for the same percent PFAS reduction. Of importance, high PFOA/PFOS removal efficiencies were achieved over the range of salt concentrations tested (i.e., 100 to 1000 μS/cm).

### Batch Testing Program Operating Parameters Impacting Performance

The primary operating conditions monitored included conductivity, pH, voltage, current, and treatment time. The operating conditions were evaluated using multiple linear regression to identify key parameters affecting PFAS removal. The effects of temperature were not evaluated in this test although temperature was monitored as later discussed herein. In assessing the primary data set, the most significant operational parameters were determined to be current, treatment time, and initial feed conductivity. The current and time parameters were combined and are reported as mA minutes (mA-min) per 1000 gallons treated in this report. This value can be converted to Coulombs by multiplying mA-min by 0.06.

The primary data set evaluated in this section includes data from Runs 1-0-26, 1-0-27, 1-1-(1-9), 1-2-(1-9), and 1-3-(1-9), which represents the main test series (MTS).

Other evaluations outside the MTS included the following:
Test 1-4-(1-9)—conducted by substituting Nafion® 117 membrane for the Fumasep® FKS-50 membrane (included in MTS).
Test 1-5-(1-3)—conducted at 3.2 centimeter (cm) electrode spacing
Test 1-6-(1-3)—conducted at 4.0 cm electrode spacing
Test 1-10-(1-3)—conducted using expanded graphite inside the AEM and CEM chambers
Test 1-11-(1-3)—conducted to evaluate the effect of higher AEM and CEM chamber conductivities on performance

Test 1-4 was conducted using Nafion® 117 membrane in the CEM, and Test 1-5 and 1-6 were conducted at different electrode separation by increasing the volume (thickness) of the feed chamber. The results and findings from each of the above tests are discussed below.

TABLE 3-1
PFAS and Salt Removal Results-Activity I

| | | | Total | | | | Total | | | | | |
|---|---|---|---|---|---|---|---|---|---|---|---|---|
| | | | Current | | | | PFOA | | | | | |
| | Outlet | Outlet | Applied | | | | and | | | | | |
| | PFOA | PFOS | (A-hr)/ | | PFOA | PFOS | PFOS | Initial | Final | Salt | Electrode | |
| Test/ | Conc. | Conc. | 1000 | Voltage | Removal | Removal | Removal | Cond. | Cond. | Removal | Spacing | |
| Run | (ppb) | (ppb) | gal.) | (VDC) | (%) | (%) | (%) | (μS/cm) | (μS/cm) | (%) | (cm) | AEM/CEM |
| 1-0-26 | 0.94 | 0.94 | 499.1 | 30 | 98.9 | 97.3 | 98.4 | 500 | 11.2 | 97.76 | 2.5 | FAS/FKS |
| 1-0-27 | 5.06 | 1.51 | 139.2 | 59 | 93.8 | 95.6 | 94.4 | 507 | 2.7 | 99.47 | 2.5 | FAS/FKS |
| 1-1-1 | 0.48 | 1.67 | 36.0 | 10 | 7.59 | 98.3 | 34.6 | 54.6 | 26.7 | 51.1 | 2.5 | FAS/FKS |
| 1-1-6 | 1.79 | 1.35 | 81.5 | 30 | 97.8 | 96.1 | 97.3 | 54.7 | 0.5 | 99.1 | 2.5 | FAS/FKS |
| 1-1-8 | 1.00 | 1.07 | 167.8 | 50 | 98.8 | 96.69 | 98.2 | 53.5 | 0.8 | 98.5 | 2.5 | FAS/FKS |
| 1-1-9 | 0.59 | 0.66 | 97.7 | 50 | 99.3 | 98.1 | 98.9 | 51.7 | 0.7 | 98.7 | 2.5 | FAS/FKS |
| 1-2-2 | 54.63 | 53.51 | 57.8 | 10 | 33.0 | −54.6 | 6.94 | 479 | 380 | 20.7 | 2.5 | FAS/FKS |
| 1-2-3 | 81.59 | 76.27 | 372.7 | 10 | 6.5 | 17.48 | 9.8 | 494 | 108.5 | 78.0 | 2.5 | FAS/FKS |
| 1-2-6 | 1.90 | 1.10 | 1542.2 | 30 | 97.7 | 96.8 | 97.4 | 442 | 3.7 | 99.2 | 2.5 | FAS/FKS |
| 1-2-9 | 0.51 | 0.40 | 1498.8 | 50 | 99.4 | 98.8 | 99.2 | 509 | 3.7 | 99.3 | 2.5 | FAS/FKS |
| 1-3-1 | 47.94 | 41.44 | 62.2 | 10 | 41.2 | 19.7 | 23.1 | 960 | 800 | 16.7 | 2.5 | FAS/FKS |
| 1-3-3 | 28.31 | 9.90 | 98.7 | 10 | 65.3 | 71.4 | 67.1 | 936 | 20.6 | 97.8 | 2.5 | FAS/FKS |
| 1-3-5 | 14.99 | 10.28 | 1042.6 | 30 | 81.6 | 70.3 | 78.3 | 967 | 22.2 | 97.7 | 2.5 | FAS/FKS |
| 1-3-9 | 1.76 | 1.37 | 797.8 | 50 | 97.8 | 96.0 | 97.3 | 951 | 5.7 | 99.4 | 2.5 | FAS/FKS |
| 1-4-9 | 3.93 | 1.19 | 515.4 | 50 | 95.2 | 96.6 | 95.6 | 501 | 1.7 | 99.7 | 2.5 | FAS/Nafion |
| 1-5-3 | 13.17 | 4.53 | 889.6 | 50 | 83.9 | 86.9 | 84.8 | 512 | 7.1 | 98.6 | 3.2 | FAS/FKS |
| 1-6-3 | 33.28 | 11.72 | 1129.5 | 50 | 59.2 | 66.1 | 61.3 | 518 | 29.9 | 94.2 | 4.0 | FAS/FKS |

### Salt Removal Results

Salt removal results are summarized

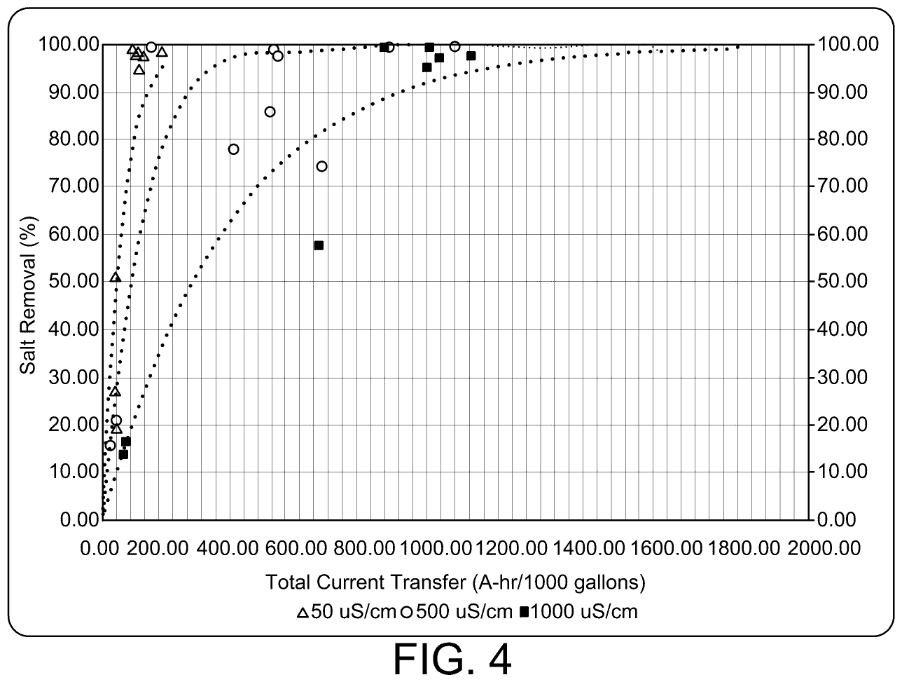

in FIG. 4. The mass removal in milligrams of NaCl, is based on a module volume of 63.9 milliliters (mL).

### Correlation of Salt and PFAS Removal

A key evaluation of this test involved valuating possible relationships between salt removal and PFOA and PFOS removal. FIG. 6 shows that there is a correlation between salt removal and PFOA/PFOS removal. Due to the focus on demonstrating removal, most of the removal results are greater than 95% for both PFOA/PFOS. Therefore, it is difficult to establish a clear correlation across the range of removals. The correlation is also impacted by analytical uncertainty. At salt removals above 95% and for conductivities between 50 and 500 μS/cm, total PFOA and PFOS removal is greater than 90 percent. For the 1000 μS/cm initial feed conductivity case and at salt removal above 95 percent, total PFOA and PFOS removal ranged from 70 to 99.5 percent.

### Operating Parameter Observations

Operating parameters impacting scale-up will include current density across the membrane and electrode surface area, and parameters related to module resistance that will impact energy costs. Resistance parameters primarily include operating voltage, total module thickness, Feed Chamber conductivity, and AEM/CEM Chamber conductivity. Voltage was found to directly impact cell resistance in that higher voltages increase electrolysis of water, increasing the ionic concentration with a corresponding increase in ion flux and a nonlinear reduction in solution resistance

### Current Density

The effective exposed surface (membrane and electrodes) of the tested AEC module was 74 cm². The average current over the MTS was 48 mA (average of run averages), with the highest test run value of 186.1 mA (Test 1-3-7 average current). The average current density was 6.49 Amps per square meter (A/m²), and the highest run average current density was 25.14 A/m².

During batch testing, initial currents were high, and as time progressed the current decreased in an exponential decay relationship over time. Due to a quickly dropping current it was difficult to read the initial instantaneous value. Initial recorded current averaged 194 mA (26.2 A/m²), with a single run maximum reading value of 667 mA (90.1 A/m²).

During testing, a run was attempted at 5 amps (676 A/m²); however, the AEM was destroyed at this current load.

### Electrode Separation Distance

Tests 1-5 and 1-6 were conducted to evaluate the effect of electrode separation distance on AEC performance. The effect is discussed further below. During the MTS electrode separation was constant at 2.5 cm.

### Module Electrical Resistance

Electrical resistance across the module averaged 1,987 ohms over the MTS, with a maximum of 7,576 ohm (Run 1-1-9). Overall module resistance was highest for the low salt content runs. Over the 50, 500, and 1000 uS/cm tests, overall module resistance averaged 3,389, 958, and 934 ohms, respectively. Additional discussion is provided herein.

### Total Current

Total current across the module averaged 480.1 mA-min over the MTS, with a maximum run average of 1,562 mA-min (Run 1-2-6). Total current was highest during the lowest salt content tests. Over the 50, 500, and 1000 uS/cm tests, total module current averaged 88.5, 662, and 700 mA-min, respectively.

On a per 1,000-gallon treated basis, the above translates to an average of 474 A-hr/1000 gallons over the MTS, with a maximum single run average of 1,542 A-hr/1000 gallons (Run 1-2-6). Total current was highest during the high salt content test. Over the 50, 500, and 1000 uS/cm tests, overall module resistance averaged 87.4, 663.6, and 691 A-hr/1000 gallons, respectively.

### Energy Consumption

Energy consumption during the testing was measured during testing using an ammeter installed in-line with the power supply and AEC module.

Total energy requirements averaged 17.52 KW-hr over the MTS, with a maximum of 75.91 KW-hr (Run 1-2-9). The overall energy requirement was highest during the high salt content run. Over the 50, 500, and 1000 uS/cm tests, AEC module energy requirements were 3.19, 25.14, and 24.6 KW-hr, respectively.

On a per 1,000-gallon treated basis, the above translates to an average of 17 KW-hr/1000 gallons over the MTS, with a maximum run average of 1,542 KW-hr/1000 gallons (Run 1-2-6). Overall current was highest over the high salt content test. Over the 50 500, and 1000 uS/cm tests, power requirements averaged 3.11, 24.51, and 23.98 KW-hr/1000 gallons, respectively.

### Activity I Analytical Quality Assurance

A number of QC (quality control) measures were implemented during testing to evaluate the quality of the test results. Sampling-specific measures included feed spike checks, reagent blanks, and equipment feed stock spikes.

An initial QC check suite of samples was submitted prior to the main Activity 1 sample submittal. Results are presented in Table 3-3.

TABLE 3-3
Activity I Analytical QC Results

| Run #/ | | PFOA | PFOS | | | % ¹³C | % ¹³C |
|---|---|---|---|---|---|---|---|
| Sample | UTK | Conc. | Conc. | ¹³C | ¹³C | PFOA | PFOS |
| ID | Label | (ppb) | (ppb) | PFOA | PFOS | Recovery | Recovery |
| 1-0-EB1 | BL2 | 112.24 | 40.94 | 1.49 | 1.14 | 149.23 | 113.57 |
| 1-0-TS1 | BL7 | 83.48 | 39.90 | 0.98 | DN | 97.91 | NA |
| 1-2-TS1 | BL24 | 79.69 | 29.33 | 0.65 | DNQ | 64.76 | NA |
| 1-3-9AEM | BL25 | 0.38 | 0.47 | 2.01 | 1.24 | 201.36 | 127.12 |

DNQ = laboratory did not quantify

Feed stock sample (1-0-EB1) was collected and analyzed to determine whether the concentration of PFOA/PFOS placed in the feed cell of the AEC would be impacted when allowed to remain in the AEC feed chamber for 20 minutes with no power. The results showed results reasonably consistent with 1-0-TS1 and 1-0-TS2, which were both spiked with 100 ppb of each PFOA and PFOS. This testing is significant because it showed that there was effectively no sorption onto the AEM over the 20-minute period of the test where there was no current flow through the cell.

A review of the Activity I analytical results showed PFAS ¹³C surrogate recoveries varied widely, with most outside the target recovery range. PFOA ¹³C recoveries ranged from 33.9 to 307 percent, and PFOS ¹³C recoveries ranged from 56.2 to 229 percent recovery.

Subsequently, four additional samples were prepared to evaluate this issue. They included two 100 ppb feed solutions (1-0-28 and 1-0-29), one 10 ppb feed solution (1-0-29), and Sample 1-0-30, a re-run of Sample 1-3-8AEM (AEM chamber concentrate). Results showed that a majority of the ¹³C spike recovery variability issue experienced with the Activity 1 samples appeared to have been due to the low spiking volume of 1 uL, which was increased to between 2 to 10 uL for supplemental samples. Supplemental sample analytical results are summarized in Table 3-4. The AEM sample was submitted to evaluate the fate of the PFAS, and showed a very low PFAS concentration.

TABLE 3-4
Supplemental Activity I Analytical QC Results-Activity I

| | | | | | 13C | 13C |
|---|---|---|---|---|---|---|
| | | Actual | | | PFOA | PFOS |
| | | (each | PFOA | PFOS | Recovery | Recovery |
| Sample | Description | ppb) | (ppb) | (ppb) | (%) | (%) |
| 1-0-28 | Feed | 100 | 51.97 | 46.79 | 43.64 | 34.18 |
| 1-0-29 | Feed | 100 | 51.76 | 48.59 | 45.99 | 35.23 |
| 1-0-31 | Feed | 10 | 12.13 | 10.02 | 80.39 | 72.82 |
| 1-0-30 | AEM | App. | 1.67 | 0.9 | 108.1 | 90.58 |
| | | 100 | | | | |

Results from Table 3-4 show the following:
The 100 ppb feed stock supplemental samples (1-0-28 and 1-0-29) were analyzed at 47-52 ppb for both PFOA and PFOS. If corrected for recoveries, the results are close to the actual 100 ppb spiked.
The 10 ppb feed stock was analyzed to be 12.13/10.02 ppb PFOA/PFOS. Results show good agreement with the actual feed stock.
Overall, the higher ¹³C spiking levels resulted in lower percent recovery variability than shown in Table 3-3.

The last sample (1-0-30) was the concentrate contained within the AEM-electrode chamber. This should have held the PFOA/PFOS mass transferred from the center feed chamber, and should have been at a PFOS concentration about the same as the test stock (TS) samples, between 40 to 50 ppb PFOA and PFOS (100 ppb each in actual feed). This analytical result was consistent with the previous anode chamber sample (Sample 1-3-8AEM), which was an identical run. It was believed that the PFOA/PFOS was either collecting on the electrode and/or the membrane, and not in the liquid. It was also thought that the PFOA/PFOS could be modified or degraded within the anode chamber. Because ¹³C recovery was good on this AEM liquid sample, there did not appear to be issues with the analytical process.

### Equipment Checks and Calibration.

The primary test monitoring activities consisted of pH, conductivity, voltage, current, pH, mass, and conductivity measurement. The pH meter was calibration checked periodically using pH 4.01, 7.00, and 10.01 standards. The conductivity meter was initially calibrated and calibration checked using 23, 447, and 12,880 standards by Oakton and Atlas Scientific. Volt and current meters were checked by comparing results from multiple instruments. The current and voltage meters on the power supplies were found to be inaccurate, and test instruments were wired into the power supply circuit to obtain the correct current and voltage readings.

### PFAS Removal Findings

During Activity I both PFOA and PFOS were spiked into a sodium chloride and DI water solution each at 100 ppb, for a total of 200 ppb. Findings associated with the MTS performance are as follows:
The AEC is capable of removing a high percentage of the PFOA and PFOS from the Feed Chamber in a batch operating mode.
High feed PFOA/PFOS removal efficiencies are achievable over the range of salt concentrations tested (i.e., 50 to 1000 μS/cm).
Total and individual PFOA and PFOS removal can be approximated based on salt removal.
Module electrical resistance increases with reduced Feed Chamber concentration
Removal efficiencies for both PFOA and PFOS are equivalent under the range of operating conditions tested.
The removal efficiency is dependent on total current transferred across the AEC, with higher removal experienced at higher total current (i.e., A-hr).
More current and total energy is required for the same total PFOA and PFOS removal at higher salt concentrations/conductivities.
Operation at high current density will destroy the AEM membrane.

### Other Findings

Other findings related to operation as follows:
AEM easily deformed during operation. The were no significant deformation issues with the CEM.
Removing the CEM (operating without CEM) caused destruction of the AEM. Therefore, for an effective AEC the use of both an AEM and CEM appear to be necessary.
During testing using a gold-plated anode, the gold eventually dissolved in the AEM Chamber during operation. A more durable anode will be required for subsequent testing and commercial operation. A platinum coating is frequently used in such applications.
Sediment accumulations were found after each test run inside the AEM Chamber. The CEM Chamber and CEM electrode appeared unaffected by the Activity I testing.
It was discovered that a planned methanol rinse of the membrane could not be used because the methanol dissolved the membrane. In lieu of a methanol rinse, a HPLC grade water rinse was used.
AEC can be used to produce water of DI water standards, which may also have commercial applications.

### Activity I (Batch Testing) Conclusions and Areas for Future Study

The results from Activity I demonstrated that the AEC can remove a high percentage of PFOA and PFOS from aqueous streams initially at 100 ppb (each). The power required to achieve the removal depends on the initial feed conductivity. At the lowest conductivity tested (50 uS/cm), less than 200 A-hr/1000 gallons were required to achieve PFOA/PFOS average removal greater than 98 percent. During testing where conductivity was 20 times higher, less than 800 A-hr/1000 gallons was required to achieve a PFOA/PFOS average of greater than 98 percent removal (about 4 times higher current).

### Flow-Through Aec Testing Results—Activity II

Activity II (flow through testing) was conducted subsequent to Activity I (batch testing). During Activity II, two PFAS feed concentrations were used for each PFOA and PFOS. These included 10 ppb and 2 ppb. These levels were considerably lower than the feed concentration of 100 ppb used in Activity I testing. The range of 2 to 100 ppb spans typical levels of industrial PFAS contamination.

### Description of AEC Module

In Activity II, the AEC module was configured the same size as in Activity I, but modified to allow flow-through operation. Key AEC modifications included adding flow connections between the three cells in each chamber, additional between-chamber flow paths, and gas vents.

### Flow-Through Testing Protocol

Flow-through testing involved operating the AEC over a range of feed salt concentrations, flow rates, voltages, and currents. Because the same AEC volume was used on all tests, the flow rate was proportional to the residence time. Electrical current was controlled by adjusting voltage to achieve a given feed outlet conductivity target value. Initial runs Test 2-0, Runs 1-11 were conducted to gain familiarity with the performance on the test solution, which consisted of sodium chloride mixed into DI water at concentrations of 75, 250, and 500 mg/L. During testing the conductivity was measured using a conductivity meter as uS/cm. Conductivity can be adjusted to mg/L NaCi by multiplying by a factor of 0.5.

Testing under the test matrix was conducted to obtain target salt removal of 40, 80, and greater than 98 percent in the outflow from the feed chamber.

### Modifications to Original Activity I Protocol

Modifications from the original test described earlier protocol are as follows:
It had originally been anticipated that two AEC modules would be required in series for the flow-through testing. It was found that project objectives could be met with a single AEC module.
One additional test was added (2-8, Runs 1-3) to allow performance evaluation at different residence times while operating at the same total current.
One additional test was added (2-9, Runs 1-3) to allow performance evaluation at a high AEM chamber concentration factor.
It had originally been anticipated that only three feed samples would be analyzed. It was decided to analyze each test's feed samples for use in removal calculations.
Feed concentrations were originally planned at 1 and 10 ppb. However, the low concentration was increased to 2 ppb to provide more definitive quantification at the analytical laboratory.
The original temperature range was expected to be 20 to 25° C. This was increased to 25 to 30° C. The low temperature test condition temperature was reduced from 15° C. to 4° C. to better show potential impact of temperature.

### Results

Results from the flow-through testing are presented for both PFAS removal and salt removal in the following text

### PFAS Removal Results

PFOA and PFOS results from the Activity II AEC testing are presented in Table 4-1. All Activity II tests were conducted at the same electrode spacing and using the same ion exchange membranes (FumaSep® membrane) as were used during Activity I.

Test results show effective removal of both PFOA and PFOS. The electrical current setting for each test was adjusted to achieve target removals of 40, 80, and greater than 98 percent salt removal. As noted in Activity I testing, above about 95% removal the removal curve flattens considerably with only small incremental gains in removal achieved with additional power input. Total PFOA and PFOS removal ranged from 95.6 to 98.7 percent when the AEC was operated to achieve better than 98% salt removal.

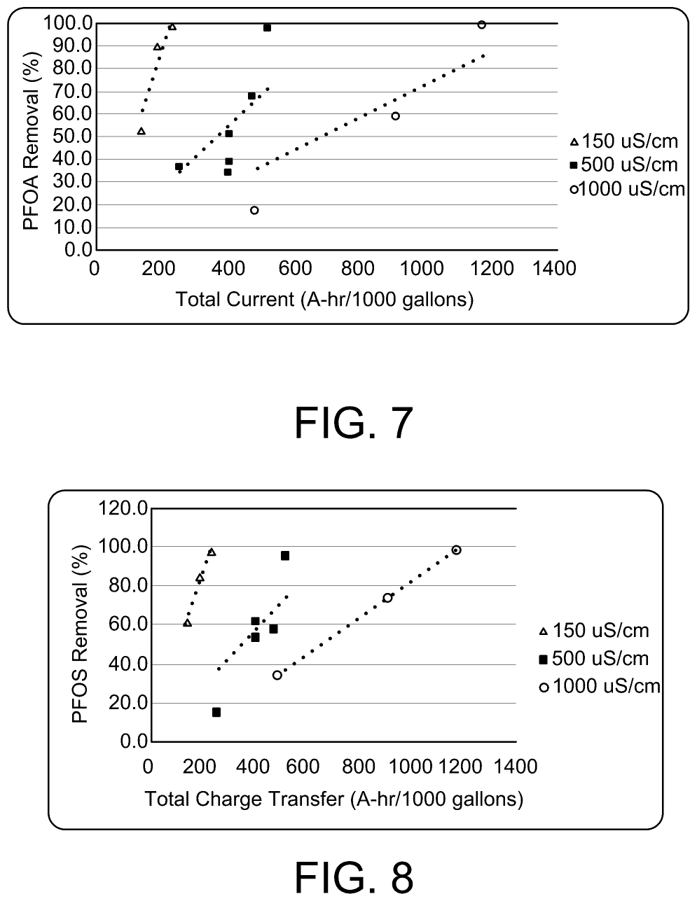

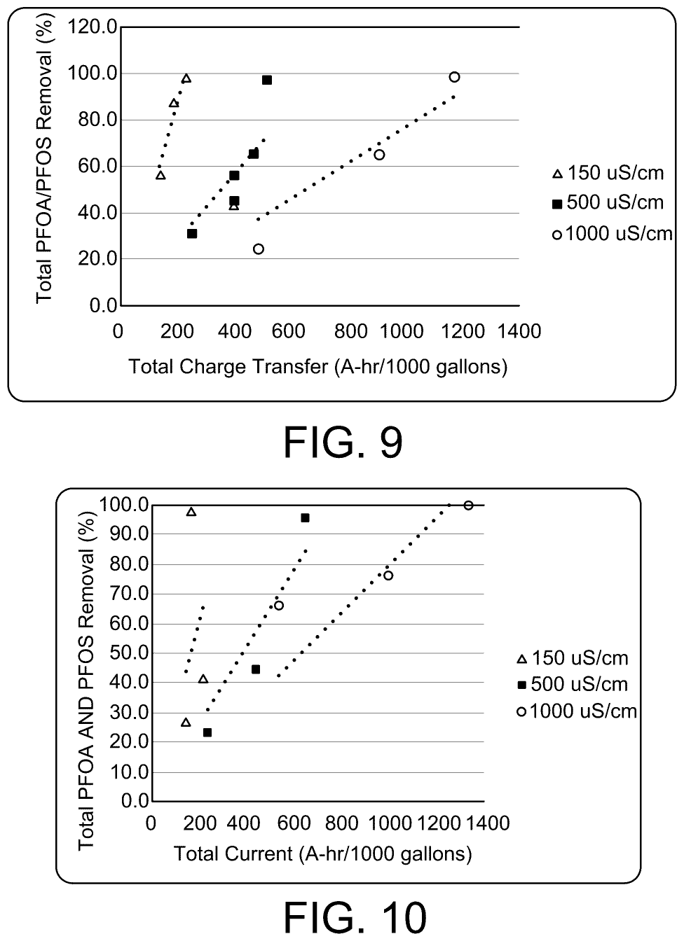

FIG. 7 shows how PFOA removal varied with total current (electrical charge transfer through AEC) at 10 ppb of PFOA initially in the feed. FIG. 8 is the same chart for PFOS at a feed concentration of 10 ppb of each PFAS initially in the feed. The charts show nearly identical performance for PFOA and PFOS removal. FIG. 9 presents total PFOA and PFOS removed. The trend lines in these graphs is plotted through zero to simplify interpretation of trends.

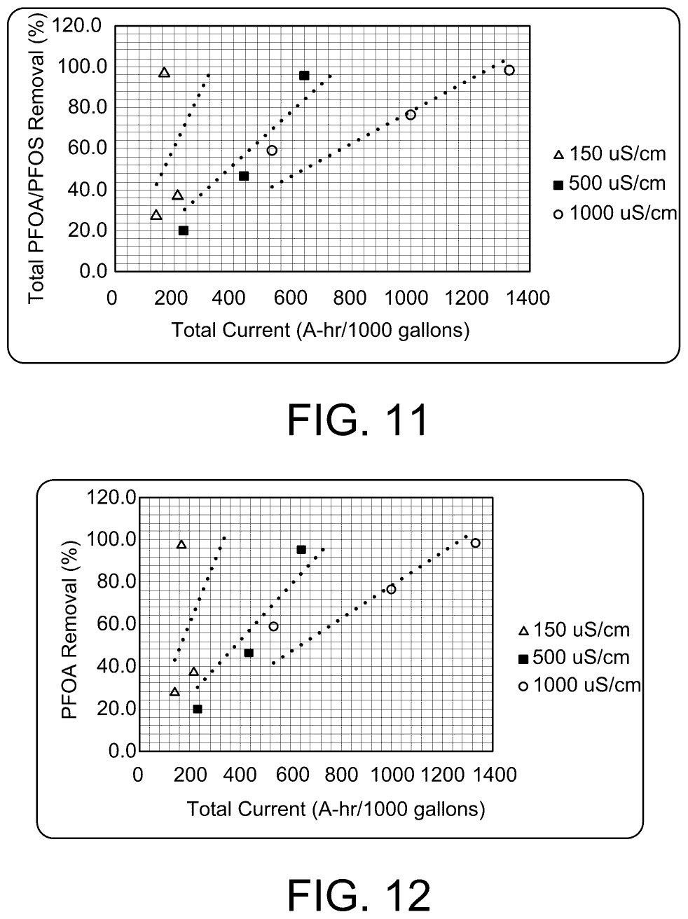

FIG. 10 shows how PFOA removal varied with total current at 2 ppb of each PFAS in the feed. FIG. 11 present the same information but for PFOS at a feed concentration of 2 ppb. The charts show nearly identical removal for PFOA and PFOS. FIG. 12 is the same chart for both PFOA and PFOS combined.

The results from FIGS. 7-12 were compared with regard to achieving a target value of 0.070 ppb total PFOA and PFOS in the treated water. At 10 ppb feed, the required removal is 99.3 percent, and at 2 ppb the required removal is 96.5 percent. Table 4-1 provides an estimate of expected total current required to achieve the target final concentration value. The results suggest that between 4 to 40 percent more total current is required to achieve the same removal result at 2 ppb as opposed to 10 ppb feed concentration.

TABLE 4-2
Total Current to Achieve 70 ppt Target

| | Feed | Feed | |
|---|---|---|---|
| | Concentration | Concentration | |
| Feed | 10 ppb | 2 ppb | |
| Conductivity | (A-hr/1000 | (A-hr/1000 | |
| (uS/cm) | gal) | gal) | Ratio |
| 150 | 240 | 320 | 1.33 |
| 500 | 520 | 730 | 1.40 |
| 1000 | 1,190 | 1,240 | 1.04 |

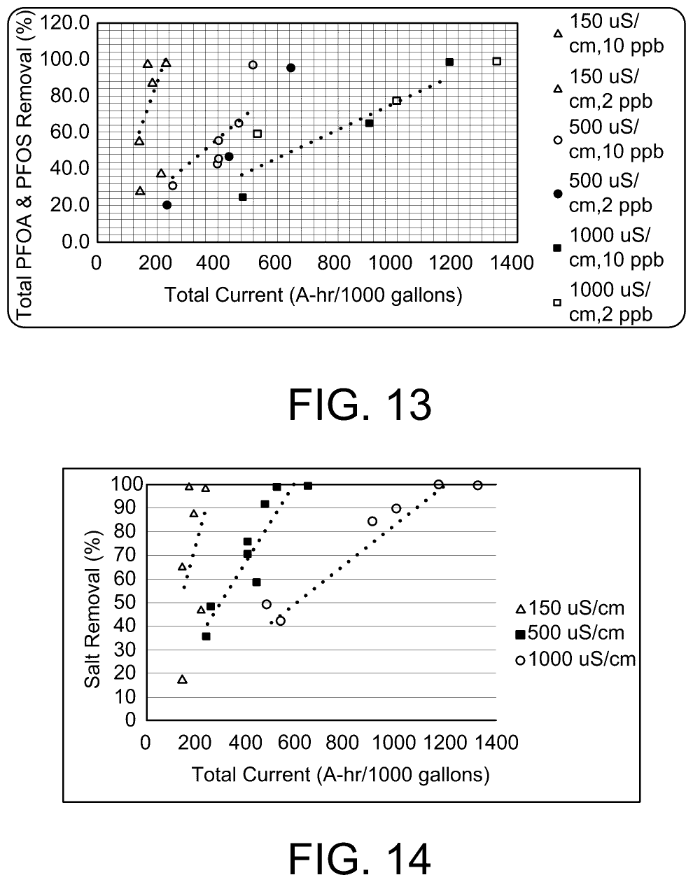

Total PFOA and PFOS removal at 2 ppb and 10 ppb is plotted against total current in FIG. 13.

### Salt Removal Results

Salt removal results correlation between total current and salt removal follows a pattern very similar to that of the tested PFAS as shown in FIG. 14.

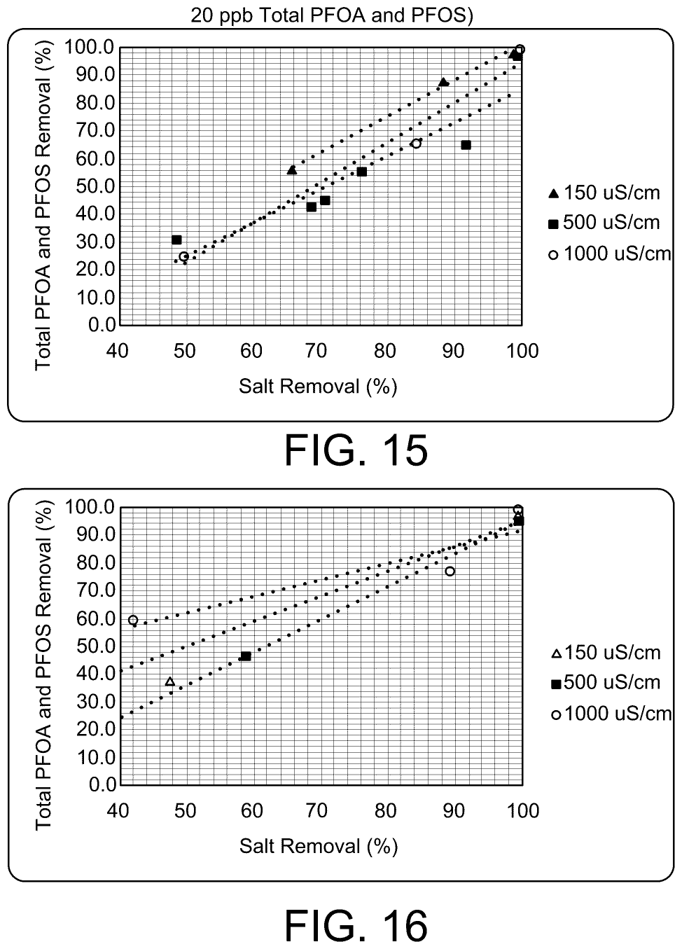

FIGS. 15 and 16 show PFOA and PFOS removal as a function of salt removal. The correlation is strong enough to make approximate estimates of PFAS removal at a given percentage salt removal.

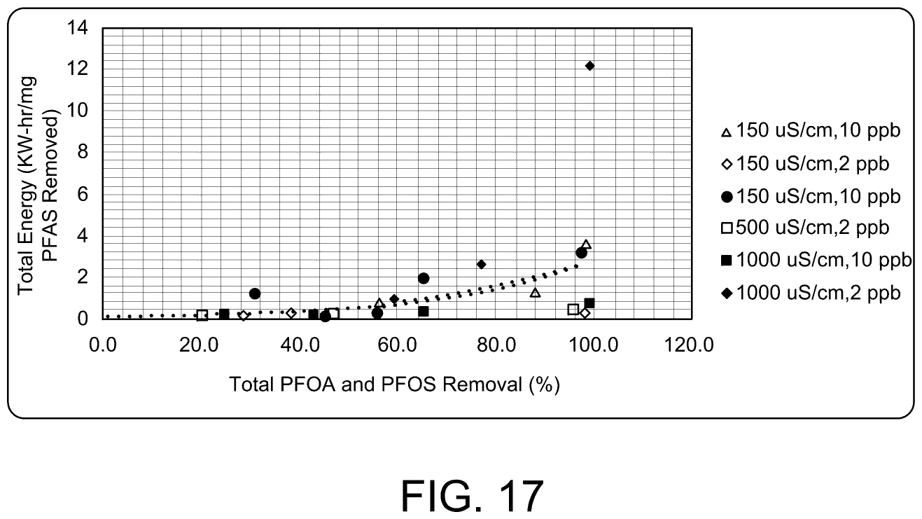

FIG. 17 is a plot of total energy requirements per unit mass (PFOA and PFOS) removed, as related to percentage total PFOA and PFOS removal.

### Relationship Between Total Current and Required Energy

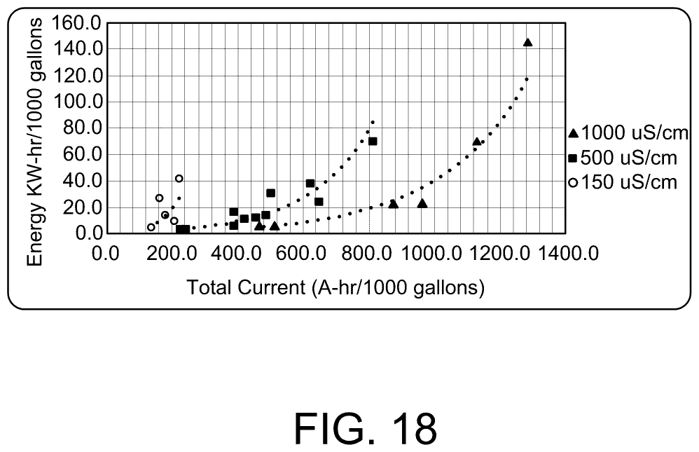

With the AEC there are a number of operating parameters interacting both independently and between parameters that govern the total energy requirement for a given total current. The primary factor influencing required energy is the inlet feed conductivity, which is shown in FIG. 18. As shown in the chart significantly more energy is required at lower concentrations at the same total current requirement.

### Other Testing

In addition to the MTS, other operating conditions were evaluated to gain additional insight with respect to a specific operating parameter.

The primary data set evaluated included Runs 2-1 through 2-6 which represent the MTS for Activity II testing. Other evaluations outside the main data set and are discussed further in later discussion. These tests included the following:
Test 2-7 Evaluated the effect of lower temperature on performance
Test 2-8 Evaluated the effect of feed chamber flow rate (i.e., velocity) on performance
Test 2-9 Evaluated the effect of higher AEM and CEM chamber conductivities on performance
Test 2-0-16 Evaluated fate of tested PFAS in the AEM and CEM chambers
Test 2-7 was conducted with a feed temperature of around 4° C. and at conditions that allowed comparison to Test 2-4. Test 2.8 was conducted by holding the total current at near 400 A-hr/1000 gallons, while operating at different feed rates. Test 2-9 was conducted by increasing the ratio between the feed rate and AEM/CEM flow rates, to produce a higher concentration factor. Test 2-0-16 was conducted to evaluate the fate of PFAS in the AEM chamber. This test was conducted by duplicating earlier tests, and starting with a feed concentration of 1,000 ppb of each PFOA and PFOS. The resulting samples were analyzed for potential degradation products. Additionally, a fluorine analysis was conducted.

### MTS Operating Parameters and Observations

The primary operating conditions monitored during the test program included conductivity, temperature, pH, voltage, current, and the flow rate in each chamber.

### Current Density

The effective exposed surface (individual membrane and electrode—single exposed surface) of the tested AEC module was 74 cm², the same as in Activity I testing. The average current over the MTS was 79.5 mA (average of run averages), with the highest run value of 125 mA (Test 2-6-3). The average current density was 1.07 mA/cm², with a maximum current density of 1.69 mA/cm². The highest current and current density of all the test runs was 215.7 mA, and 2.91 mA/cm², respectively. Variations of current densities outside these ranges is allowable.

### Module Electrical Resistance

Electrical resistance across the module averaged 590 ohm over the MTS, with a minimum test run average of 330 ohm (Run 2-1-1), and a maximum single run average of 1,133 ohm (Run 2-2-3). Additional discussion of electrical resistance is provided elsewhere.

### Total Current

The total current passed through the AEC module averaged 512.1 A-hr/1000 gal., with a minimum test run average of 138.7 A-hr/1000 gal. and a maximum test run average of 1,332.7 A-hr/1000 gal.

### Total Energy Consumption

Energy consumption averaged 25.9 KW-hr per 1000 gallons (KW-hr/1000 gal.) over the MTS. The highest single run energy consumption was 145.9 KW-hr/1000 gal (Run 2-2-3) and the lowest was 3 KW-hr/1000 gal (Run 2-3-1). Over the 150, 500, and 1000 uS/cm conductivity tests, the required energy averaged 17.5, 16.8, and 46.1 KW-hr/1000 gallons.

### AEC Flow Rates Feed Flow Rate

Feed flow through the AEC system was conducted at 5, 10, and 35 mL/min over the Activity II testing program. Actual AEM and CEM chamber flows ranged from 4.9 to 35.3 mL/min. AEM and CEM chamber flow rates were maintained close to the same flow rates. Over the MTS the AEM and CEM flows averaged 4.1 mL/min and 4.2 mL/min, respectively.

During testing a vent port was placed in the AEM chamber to handle gas generation. An extra port was not required on the CEM chamber. There was no quantification of gas generation rate from the AEC. Gas generation will be a consideration in scale up and can be calculated based on the rate of water hydrolysis and cell efficiency using Faraday's Law.

### AEM and CEM Chamber Conditions

During the MTS the anode pH ranged from 2 to 2.8, and the cathode 10.9 to 12. Conductivity in the AEM ranged from 1,431 to 3530 uS/cm, and 937 to 3257 in the CEM. The Activity II MTS conductivity averages for the AEM and CEM were 2,412 and 1,819 uS/cm, respectively.

### Activity II Quality Assurance

A number of QC measures were implemented during Activity II testing to evaluate the quality of the results. Sample-specific measures included use of an equipment blank, and the analysis of more feed solution samples than originally planned. The additional feed samples were collected due to the low surrogate recoveries experienced in Activity I to provide a more consistent comparison between inlet and outlet concentrations.

The primary quality measure used to evaluate analytical results was ¹³C surrogate recoveries. These isotopically labeled surrogates were added after the samples were received at the testing facility, but before concentration and analysis. Prior to sample submittal to the laboratory samples were stored in a refrigerator at 6° C., preserved with Trizma®, and transferred to the testing facility in coolers on ice.

The surrogate recoveries for Activity II testing are summarized in Table 4-3. Depending on the test feed stock either 10 uL or 2 μL of ¹³C labeled compound was added.

TABLE 4-3
Surrogate Recoveries-Activity II PFAS Analyses

| Run #/ | | PFOA | PFOS | ¹³C PFOA | ¹³C PFOS | % ¹³C | % ¹³C |
|---|---|---|---|---|---|---|---|
| Sample | UTK | Conc. | Conc. | Recovered | Recovered | PFOA | PFOS |
| ID | Label | (ppb) | (ppb) | (ppb) | (ppb) | Recovery | Recovery |
| 2-1-TS | BL49 | 14.11 | 10.26 | 8.62 | 5.58 | 86.3 | 55.8 |
| 2-2-TS | BL 69 | 2.038 | 1.166 | 5.89 | 4.6 | 58.89 | 45.96 |
| 2-3-TS | BL 50 | 14.07 | 7.74 | 9.13 | 5.58 | 91.3 | 55.8 |
| 2-4-TS | BL 70 | 1.905 | 0.745 | 6.04 | 4.72 | 60.41 | 47.20 |
| 2-5-TS | BL 51 | 14.97 | 7.90 | 8.64 | 5.48 | 86.38 | 54.8 |
| 2-6-TS | BL 71 | 1.954 | 1.208 | 6.19 | 4.61 | 61.91 | 46.10 |
| 2-7-TS | BL 72 | 7.995 | 5.036 | 4.96 | 3.85 | 49.64 | 38.52 |
| 2-8-TS | BL 52 | 14.76 | 10.43 | 8.48 | 5.54 | 84.84 | 55.4 |
| 2-9-TS | BL 73 | 7.272 | 4.734 | 4.66 | 3.87 | 46.58 | 38.66 |
| 2-1-1 | BL-53 | 11.67 | 6.73 | 10.14 | 6.46 | 101.41 | 64.59 |
| 2-1-2 | BL-54 | 5.82 | 2.64 | 10.55 | 6.67 | 105.54 | 66.69 |
| 2-1-3 | BL 55 | 0.12 | 0.13 | 12.03 | 7.44 | 120.33 | 74.42 |
| 2-2-1 | BL 74 | 0.687 | 0.622 | 6.45 | 4.74 | 64.53 | 47.39 |
| 2-2-2 | BL 75 | 0.488 | 0.255 | 6.53 | 4.90 | 65.25 | 48.99 |
| 2-2-3 | BL 76 | 0.009 | 0.025 | 6.83 | 5.00 | 68.31 | 49.97 |
| 2-2-AEM | BL 89 | 0.006 | 0.018 | 6.56 | 4.77 | 65.56 | 47.74 |
| 2-2-AEM1 | BL 94 | 0.003 | 0.012 | 5.60 | 3.76 | 56.05 | 37.55 |
| 2-2-AEM2 | BL 90 | 0.002 | 0.017 | 6.42 | 4.73 | 64.20 | 47.26 |
| 2-3-1 | BL 56 | 10.78 | 6.66 | 9.14 | 5.90 | 91.37 | 58.98 |
| 2-3-2 | BL 57 | 7.8 | 3.79 | 10.15 | 6.45 | 101.55 | 64.50 |
| 2-3-3 | BL 58 | 0.59 | 0.38 | 12.07 | 7.18 | 120.66 | 71.84 |
| 2-4-1 | BL 77 | 1.203 | 0.628 | 6.11 | 4.32 | 61.12 | 43.18 |
| 2-4-2 | BL 78 | 0.608 | 0.315 | 7.01 | 5.05 | 70.11 | 50.50 |
| 2-4-3 | BL 79 | 0.035 | 0.033 | 6.12 | 5.16 | 61.22 | 51.59 |
| 2-5-1 | BL 59 | 10.94 | 5.44 | 9.60 | 6.12 | 95.96 | 61.24 |
| 2-5-2 | BL 60 | 8.73 | 5.43 | 9.72 | 6.08 | 97.18 | 60.76 |
| 2-5-3 | BL 61 | 0.31 | 0.15 | 12.15 | 7.41 | 121.53 | 74.14 |
| 2-6-1 | BL 80 | 0.921 | 0.465 | 6.07 | 4.54 | 60.67 | 45.39 |
| 2-6-2 | BL 81 | 1.181 | 0.200 | 8.03 | 5.15 | 80.31 | 51.55 |
| 2-6-3 | BL 82 | 0.024 | 0.028 | 8.04 | 4.70 | 80.40 | 47.01 |
| 2-7-1 | BL 83 | 5.709 | 3.249 | 5.29 | 3.76 | 52.89 | 37.56 |
| 2-7-2 | BL 84 | 3.487 | 1.829 | 5.51 | 4.19 | 55.06 | 41.89 |
| 2-7-3 | BL 85 | 0.289 | 0.191 | 6.78 | 5.02 | 67.84 | 50.21 |
| 2-8-1 | BL 62 | 8.96 | 4.84 | 10.03 | 6.39 | 100.25 | 63.90 |
| 2-8-2 | BL 63 | 9.65 | 4.78 | 10.03 | 6.34 | 100.30 | 63.42 |
| 2-8-3 | BL 64 | 7.18 | 3.97 | 10.54 | 6.42 | 105.45 | 64.18 |
| 2-8AEM1 | BL 65 | 0.01 | 0.03 | 10.45 | 6.91 | 104.46 | 69.11 |
| 2-8-CEM2 | BL 96 | 0.009 | 0.02 | 5.03 | 3.59 | 50.27 | 35.89 |
| 2-8AEM3 | BL 67 | 0.01 | 0.03 | 11.98 | 7.31 | 119.82 | 73.10 |
| 2-0-EB | BL 68 | 0.01 | 0.05 | 12.37 | 7.50 | 123.72 | 74.97 |
| 2-9-1 | BL 86 | 5.831 | 3.506 | 5.21 | 3.71 | 52.09 | 37.09 |
| 2-9-2 | BL 87 | 2.817 | 1.642 | 5.82 | 4.16 | 58.20 | 41.59 |
| 2-9-3 | BL 88 | 0.650 | 0.376 | 6.39 | 4.54 | 63.86 | 45.41 |
| 2-9-AEM | BL 91 | 0.002 | 0.018 | 6.3 | 4.63 | 62.99 | 46.27 |
| 2-9-AEM2 | BL 92 | 0.007 | 0.019 | 6.54 | 4.68 | 65.36 | 46.83 |
| 2-9-CEM | BL 93 | 0.005 | 0.019 | 6.69 | 4.62 | 66.90 | 46.15 |

Recoveries for PFOA were much higher than those of PFOS. The average recovery for PFOA was 80.07 percent with a range of 46.58 to 123.72 percent. The average recovery for PFOS was 53.69 percent with a range of 35.89 to 35.89. The testing facility laboratory indicated that PFOS has more interaction with surfaces than PFOA and is more prone to losses in the analytical process.

An equipment blank was prepared by placing DI water in the feed cell and removing it as a sample. The results were 0.01 ppb PFOA and 0.05 PFOS. These values are low relative to the objectives of the test.

As previously noted, feed samples from each test were analyzed. Feed surrogate recoveries for PFOA averaged 72.5 percent and 82.3 percent for treated samples. The difference in recoveries suggest that PFOA removal percentages are biased slightly lower than actual. PFOS surrogate recoveries averaged 48.7 percent and 54.7 percent. This would suggest an overall slightly higher bias to removal results. This also suggests that PFOS removals are biased slightly lower than actual. Overall the results suggest that on a total mass basis 82.3% of the actual PFOA and 54.7 percent of the actual PFOS in treated samples is being reported, presenting an overall low concentration bias.

### Equipment Checks and Calibration

The primary test monitoring parameters included pH, conductivity, voltage, current, pH, conductivity, and mass. Calibration was checked as described herein.

### PFAS Removal Findings

Findings from Activity II of the MTS are summarized below. Additional findings for other specific tests outside the MTS are described in Section 5.0.
The AEC is capable of removing a high percentage of the PFOA and PFOS from the Feed Chamber in the flow-through operating mode.
Total and individual PFOA and PFOS removal can be reasonably predicted based on salt removal in the flow-through operating mode.
Module electrical resistance increases with reduced feed chamber concentration in the flow through operating mode. This same correlation was observed in the batch testing.
There is a correlation of salt removal and PFOA and PFOS removal, as a linear function, with higher PFOA and PFOS removal achieved at a lower feed salt content.
Removal efficiencies for both PFOA and PFOS were equivalent under the range of operating conditions tested.
The removal efficiency is dependent on total current transferred across the AEC, with higher removal experienced at higher total current (i.e., A-hr).
More current and total energy is required for the same total PFOA and PFOS removal at higher salt concentrations/conductivities.
Between 4 and 30 percent more energy is required to remove total PFOA and PFOS when the initial feed concentration is 2 ppb as opposed to 10 ppb.
In comparing batch and flow-through testing results, batch operation requires lower current and energy than the flow-through mode for a given percentage PFOA and PFOS removal.

### Other Observations and Findings

Other findings related to the MTS are as follows:
When the AEC was operated without spacers inside the chamber, the AEM membrane deformed significantly to the point of causing membrane damage.
Anode vent off-gassing was significant, and approximately equal in volume to the side chamber feed rate. Off gassing was not quantified.
A white sediment was formed in the AEM chamber during all runs, and was found through analysis to consist primarily of titanium. The next generation of AEC will require use of a more durable anode electrode.
During testing it was observed that the AEM and CEM chamber pH steadily became more extreme to a point, at which time the pH stabilized, typically around 2 pH (AEM chamber), and 11.5 (CEM chamber). The same stabilization effect was also observed with conductivity.

### Activity II Conclusions

The results from Activity II demonstrated that the AEC, when operated in flow-through mode can remove a high percentage of PFOA and PFOS from aqueous streams initially at 2 and 10 ppb. The total current transfer required to achieve the removal depends on the initial feed conductivity, with higher current transfer requirements for higher initial salt concentration feeds. Additionally, PFOA and PFOS removal can be predicted by salt removal.

### Activity I AEC Resistance as Related to Feed Conductivity—Conductivity Impact

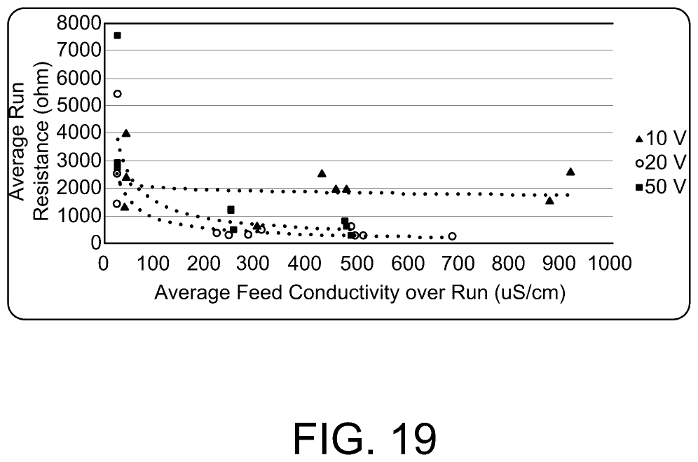

The effective AEC cell electrical resistance was calculated from measured current and voltage over each test run of the MTS. Average test cell resistance for the Activity I batch runs is presented in FIG. 19 as a function of average feed water conductivity, and at different treatment voltages. Specifically, the average run resistance is plotted against the average of the initial feed concentration and final concentration after treatment. The results show a trend of lower average resistance with an increase in average feed conductivity; although the effect is diminished at a a conductivity above 50 μS/cm. Also shown is lower resistance with higher treatment voltage.

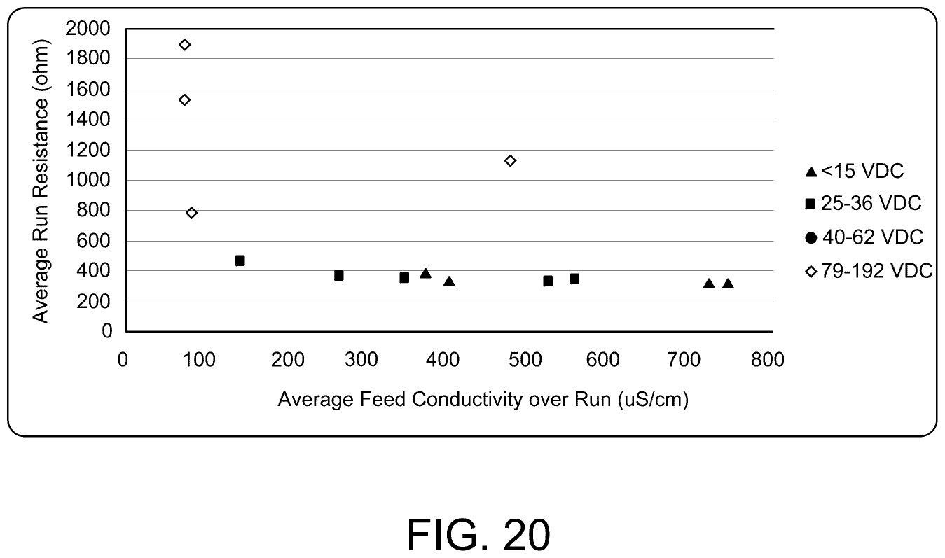

The same graph was prepared for Activity II results and is presented in FIG. 20. Activity II results show the same general trend of lower average resistance with an increase in average feed conductivity; however, the results suggest an inverted voltage effect as compared to Activity I resistance results. The trend shows a diminished impact of average feed conductivity above 100 μS/cm, similar to that observed in Activity I. The correlation of resistance with treatment voltage does not appear as strong with the flow-through runs as compared to the batch results, although as previously noted both graphs show a sharp spike in resistance at low feed conductivities.

Overall resistance was considerably lower over the flow-through test, as compared to the batch test. This difference is likely due to the longer overall residence times in Activity I that resulted in more time operating during the low feed conductivity period later in the test runs.

### Electrode Resistance and Surface Area

A test, not specifically related to AEC testing was conducted to evaluate the effect of exposed electrode surface area on cell electrical resistance. In the test, a 3-inch wide Grade 2 titanium plate was immersed in a 1,530 uS/cm sodium chloride solution at a 1.2-inch plate separation. There was no mixing of the liquid contents. Results, presented in FIG. 22 show a non-linear reduction in cell resistance as the exposed surface area increases. As observed in FIG. 19, resistance is lower at higher operating voltage, likely due to localized increased ionic strength between the plates caused by ions generated through hydrolysis, which would increase at the higher voltages.

The AEC module used during testing had an effective area of 11.32 in². The plot in FIG. 22 shows that at a larger commercial system's surface area, resistance would be reduced by a factor of about 2 times, due solely to the increased surface area.

### Electrical Resistance and Electrode Spacing

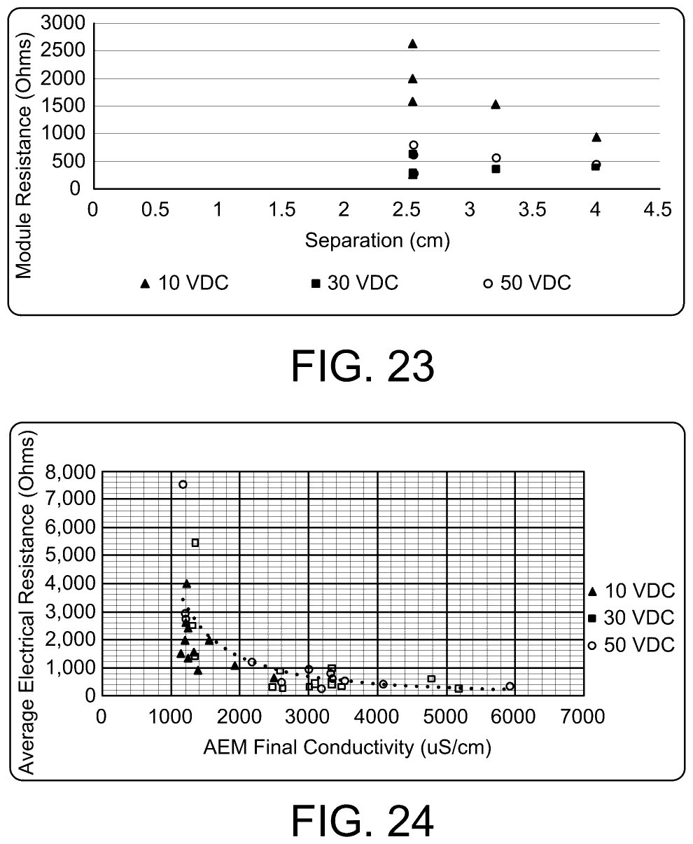

In Activity I, Tests 5 and 6, the feed chamber thickness was increased. This had the effect of changing the separation distance from 2.5 cm (MTS) to 3.2 cm (Test 5), and 4.0 cm (Test 6). These increased spacing tests were conducted at 250 mg/L NaCl, and results are shown in FIG. 23. The chart shows the same general trend of higher resistance at lower voltage as observed in FIG. 19. The chart also suggests decreasing resistance with increased electrode separation distance. There was not a similar test associated with Activity II. The next generation of AEC in the scale-up process will need to include a flow-through evaluation of electrode separation distance and Feed Chamber thickness to provide a conclusive finding relative to the impact of electrode spacing on electrical resistance.

### Membrane Chamber Ion Accumulation

Several tests were conducted during Activity I to evaluate the impact of conductivity in the side chambers on overall AEC electrical resistance. As shown in FIG. 24, the AEC electrical resistance is correlated with the final conductivity in the AEM chamber. The same relationship would hold for the CEM chamber conductivity, which correlates proportionally with AEM chamber conductivity. FIG. 24 shows that below about 1,500 uS/cm AEM conductivity, AEC cell resistance can become quite high. Above 1,500 uS/cm the electrical resistance of the cell slowly falls with increasing AEM chamber final conductivity. In the test series the side chamber stream to the middle was initially at 200 uS/cm.

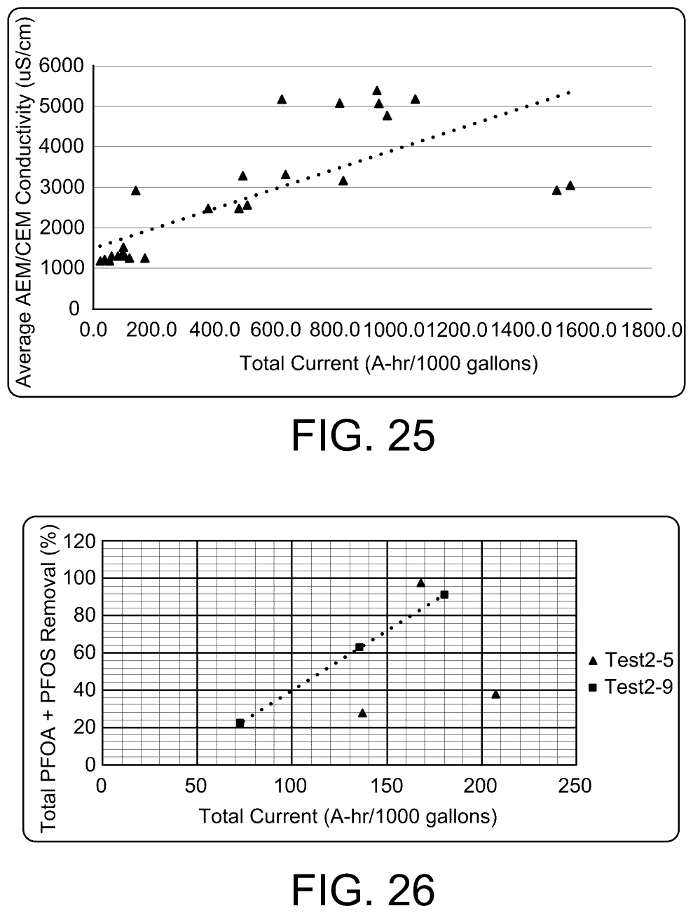

FIG. 25 shows that average AEM/CEM conductivity increases with total electrical current transferred across the AEC.

### Estimation of AEC Cell Average Resistance

The key operating parameters for the Activity I MTS were evaluated using multiple linear regression. As previously shown, there is a correlation between a number of operating parameters and AEC resistance. However, the overall correlation coefficient for parameters of statistical significance is low, at 0.45. The resulting equation is:

$$Resistance ( ohm ) = 51.889 \times ( Volts ) - 0.8918 ( AEM Cond . uS / cm ) + 2477.1$$

This equation will provide a reasonable approximation of the AEC cell resistance for the Batch testing in Activity I.

The same evaluation was performed for Activity II MTS results. The adjusted correlation coefficient is 0.93, and the p-value for voltage and AEM conductivity are 0.00 and 0.26, respectively. The resulting equation is:

$$Resistance ( ohm ) = 8.5365 \times ( Volts ) - 0.054 \times ( AEM Cond . uS / cm ) + 283.9$$

In both Activity I and II, voltage is the controlling parameter with AEM conductivity affecting resistance to a lesser extent.

### Impact of Electrode Separation on Salt Removal

In two of the tests of Activity I, different electrode separations distances were tested. FIG. 22 is a plot of salt removal as a function of energy per 1000 gallons of treated water. The separation distances of 2.5 cm, 3.2 cm, and 4 cm are represented as different colored data points on the chart. The feed chamber sizes were 63.9 mL (Test 1-4), 115.3 mL (Test 1-5), and 166.6 mL (Test 1-6), and all of the tests were conducted at an initial salt concentration of 250 mg/L, NaCl.

The results are compared to Test 1-3. The results suggest slightly lower salt removal for 3.2 cm spacing and even lower removal at 4.0 cm spacing. Interestingly, the effect of reduced salt removal is not as pronounced at higher energy input levels.

### Effect of Exfoliated Graphite on Membrane Chamber Conductivity

In Activity I, Test 1-10 (1-3), the effect of exfoliated graphite on AEC module electrical resistance was evaluated. This was not a part of the original test suite. In this test, both AEM and CEM chambers were packed with exfoliated graphite (EG). PFAS were not analyzed in this test. Performance with regard to salt removal appeared to be similar to testing conducted in Test 1-1-4. Due to the limited data, close comparison to the other run was not possible. However, the addition of the EG did not produce a significant change in the AEC overall electrical resistance.

### Operation of AEC on Local Tap Water

A test was conducted where the AEC was operated for seven (7) hours on tap water from Oak Ridge, Tennessee. AEC operating conditions ranged from 17 to 100 VDC, and 50 to 197 mA. The initial feed conductivity was 274 uS/cm. Over the first 5 hours, voltage was maintained at around 44 VDC, with current around 75 mA. Final conductivity held at around 20 uS/cm for about 3.5 hours, after which time it increased to 66 uS/cm. At 3.5 hrs the power was turned off for 5 minutes. No significant reduction in outlet conductivity was observed once power was switched on. At around 4 hours into the test the polarity was reversed for 10 minutes. Immediately upon restoring normal polarity the current increased to 250 mA and then quickly stabilized around 70 mA. There was no significant impact on salt removal performance from polarity reversal, with subsequent outlet conductivity ranging from 55 to 69.3 uS/cm.

Toward the end of the test the voltage was increased to 100 VDC, and the outlet conductivity quickly dropped to 8.5 uS/cm and stabilized near this value.

Upon concluding the test, the AEC module was opened and inspected. The electrodes appeared to be in good condition. A white precipitate was observed at the bottom of the AEC module anode chamber, with a weight of 160 milligrams (mg). The material was pasty and white in color, and did not readily dissolve in acid or base. It was subsequently tested using SEM and found to be titanium dioxide. In addition to the residue, it was also found that both the AEM and CEM membranes had migrated into the feed chamber and were resting against the center spacer. It is believed that the increase in outlet conductivity observed over the test was due to the shorter feed chamber residence time caused by the deforming membranes. The membranes both assumed their original form after soaking in salt water. It has been determined that the use of raised areas on the membranes, as discussed above is effective in preventing contact between the layers due to the distortion.

Raised areas such as extruded or adhered lines or spaced dots, preferably covering less than 10%, and preferably less that 8% of the surface area are preferred to address this issue.

This testing shows the likely need for a more durable electrode in the AEM chamber, and the need for reinforcement/support of the membranes. During scale-up care will need to be taken to minimize the potential for membrane deformation. This will include placement of spacers in the flow space or backing material integrated with the membrane.

One run was conducted at a high current of 5 amps (67.6 mA/cm²), which destroyed both membranes. AEC systems now operate at 0.05 mA/cm2 to no more than 1 mA/cm2.

### AEC Side Chamber Concentration Effects

Over the course of testing some Activity II runs allowed the evaluation of the extent concentration that could be accomplished in a single 3-chamber AEC module.

During operation of the AEC the concurrent hydrolysis of water resulted in the accumulation of hydrogen ion (H+) and chloride (Cl—) ions in the AEM chamber. This resulted in an increase in AEM chamber conductivity proportional to total current input. The pH in the AEM chamber decreased corresponding to the increase in hydrogen ion (H+). In most of the tests, the AEM chamber pH dropped to around 2.

As the feed stream is treated, PFAS and salt is transferred out of the feed stream and into the AEM and CEM chambers potentially resulting in a concentration effect. However, the definition of concentration requires further discussion. In dealing with PFAS, a certain fraction will be transferred from the Feed chamber into the AEM chamber. For example, in an AEC operated in the batch mode if 100 ppm PFAS was initially in the feed and 100 percent removed, the entire mass would then be in the AEM chamber. If the AEM chamber was the same size there would be no concentration. However, if the AEM chamber was ½ the volume the PFAS would be concentrated by a factor of 2 times.

In a flow-through system the concentration factor (CF) is calculated as follows:

$$CF = \frac{{F}_{f}}{{F}_{AEM}}$$

### Where,

CF=Concentration factor
F_{f}=Flow Rate of Feed stream
FA_{EM}=Flow rate of AEM stream

In application, if subsequent treatment of the AEM stream is used to remove the PFAS then the concentration factor applies as noted above. However, if the AEM and CEM streams are combined prior to further treatment then the AEM volume or volumetric rate must be added to that corresponding to the AEM chamber, which will reduce the extent of concentration.

During Activity I the AEM and CEM chamber sizes were the same volume so there was no concentration occurring, just transfer of the salt and PFAS from the Feed to the AEM chamber. During Activity II the concentration factor was adjusted by AEM flow rate adjustment.

### Fate of PFAS

During Activity I testing it was observed that no PFOS or PFOS was found in the concentrate chamber of the AEC. This finding was confirmed in Activity II testing.

Initial analytical activities directed at determining the fate of the PFOA and PFOS removed from the feed chamber included the following:
Analysis of the side chamber liquids (both AEM and CEM) for PFOA and PFOA
Analysis of AEM membrane HPLC water rinse for PFOA and PFOS
Analysis of AEM electrode rinse for PFOA and PFOS
Analysis of AEM electrode residue and deposits found in the AEM chamber. These residues were first extracted in methanol, taken to dryness, re-dissolved in HPLC water, and that water recombined with the AEM chamber water for analysis
During Activity I a sample was collected and analyzed after the feed was placed in the Feed Chamber with no associated current and with no loss in PFOA and PFOS content.

The results of these evaluations are presented in Table 5-3

TABLE 5-3
AEM and CEM Chamber Liquid Analytical Results

| | | | PFOA | PFOS |
|---|---|---|---|---|
| Run #/ | | UTK | Conc. | Conc. |
| Sample ID | Description | Label | (ppb) | (ppb) |
| 2-2-AEM | Test 2-2, Anode Liquid | BL 89 | 0.006 | 0.018 |
| 2-2-AEM1 | Test 2-2. Anode Rinse + Solids | BL 94 | 0.003 | 0.012 |
| | Extract | | | |
| 2-2-AEM2 | Test 2-2, AEM Rinse | BL 90 | 0.002 | 0.017 |
| 2-8AEM1 | Test 2-8, Anode Liquid | BL 65 | 0.010 | 0.030 |
| 2-8-AEM2 | Test 2-8, Anode Rinse + Solids | BL 96 | 0.009 | 0.020 |
| | Extract | | | |
| 2-8AEM3 | Test 2-8 AEM Rinse | BL 67 | 0.010 | 0.030 |
| 2-9-AEM | Test 2-9, AEM Liquid | BL 91 | 0.002 | 0.018 |
| 2-9-AEM2 | Test 2-9, Anode Rinse + Solids | BL 92 | 0.007 | 0.019 |
| | Extract | | | |
| 2-9-CEM | Test 2-9, CEM Liquid | BL 93 | 0.005 | 0.019 |

Analytical results show no significant PFOA or PFOS in either the AEM or CEM Chambers after passage through the system of the invention. Additionally, no significant concentrations of PFOA or PFOS were found in the anode electrode rinse, AEM rinse, or the sediment extract.

Subsequently, a study was undertaken to identify the fate of the two PFAS. This study was not a part of the original test plan. It was originally suspected that the PFAS was being degraded by oxidation and free radical attack at the anode. In fact, it was adsorbed. A supplemental test was developed to analyze liquid in all chambers, and generated solids.

This testing involved creating a feed sample with a higher concentration of each PFAS (i.e., 1 ppm) than was used with the “official” test matrix. This higher PFAS concentration was required to provide the necessary analytical detection of possible PFAS degradation products. Flow-through testing (Test 2-0-16) was conducted at 10.7 mL/m, at 610 to 850 A-hr/1000 gallons, and at 250 mg/L NaCl in the feed stock, producing greater than 99 percent salt removal (99.2 to 99.7 percent).

The samples from Run 2-0-16 were analyzed using a high-resolution Q Exactive (QE) Thermo Scientific Quadrupole-Orbitrap Mass Spectrometer, operated in the negative mode and set for a broad focus (nontargeted) to identify possible degradation products. This is a different instrument than the LC-MS/MS (QQQ) that was used to quantify PFOA and PFOS. Samples analyzed included AEM and CEM Chamber liquid, residue, feed, treated feed, and blank samples. The QE analysis, although non-quantitative, provided the following findings:
The QE analysis further supported the results from Phase I analytical program showing high removal of PFOA and PFOS from the feed stream.
The QE analysis identified a number of other PFAS impurities (low level impurities in the analytical standards) in the feed at lower levels than the PFOA and PFOS (i.e., C6 PFAS acid, C7 PFAS acid, C6 PFAS sulfonic acid, C9 PFAS acid), and all of these showed removals through AEC treatment similar to that of the spiked PFOA and PFOS.
The QE analysis showed no significant levels of PFOA or PFOS in any of the samples analyzed other than the relative expected chromatogram peak area ratios between in the feed inlet and outlet samples.
A large number of unknown features were detected in the QE screen across the sample types indicating the presence of potential breakdown products/pathways, many of which were not seen in the feed exit stream. Due to the high analytical sensitivity of this method, a portion of these features could be organic residues associated with PFAS impurities in the spike sample, PFAS degradation products, butyl rubber decomposition products, and AEM and CEM breakdown products. The AEM sample had the most features detected, including 26 that were only detected in the AEM. The high peak areas of the features identified in the AEM as compared to the other samples could be indicative of breakdown products.

The samples were also analyzed for fluorine, but the results were inconclusive because the samples used had been previously extracted for Method 537 analysis.

Follow-up testing was conducted to obtain more conclusive results. A 1 ppm PFOA and PFOS spike was added to the AEM Chamber feed and the sample train was operated in the same manner as 2-0-16. The sample was submitted to a local laboratory for Fluorine analysis to determine if the PFAS was being mineralized. Additionally, the same test setup was run with 10 ppb of PFOA and PFOS spiked into the AEM Chamber feed. The AEM exit sample was submitted to a commercial laboratory for PFAS analysis (24 compound list, including PFOA and PFOS). These results are not available as of this submittal.

In summary, the above results show that PFOA and PFOS are being chemically modified or decomposed within the AEC.

### Comparison of Nafion® 117 Membrane and Fumesep® FKA-50 Membrane CEM

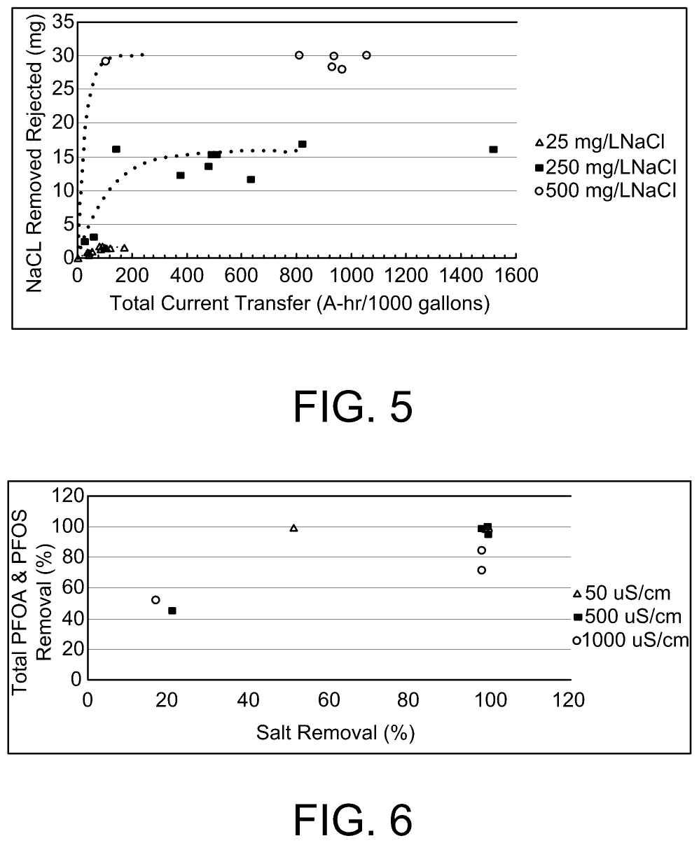

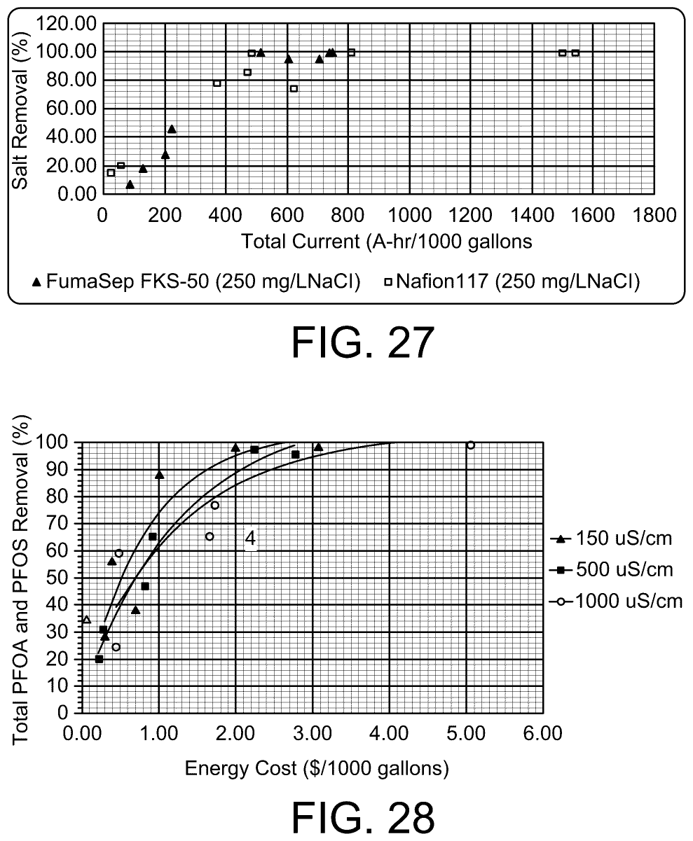

During Activity 1, Test 4, Runs 1-9, Nafion® membrane 117 CEM was used. FIG. 5-10 provides a graphical comparison of salt removal performance between Test 4 (Nafion®) and Test 3 (Fumasep® FKS-50). The Nafion® appears to require slightly lower current for a given removal, particularly at currents below 200 A-hr/1000 gallons. However, the results are not consistent throughout the graph in FIG. 27.

### Characterization of AEM Residue

During the testing noticeable residue was observed in the AEM chamber after every test. It was believed that this was most likely titanium dioxide produced from titanium eroded from the electrode. Two samples were submitted for scanning electron microscope (SEM) analysis to ascertain the elemental composition. The results are presented in Table 5-6. Sample 1 represents the dried residue (originally pasty consistency) from Run 2-0-11, and Sample 2 represents residue from test run 2-9.

### SEM Analytical Results for AEM Chamber Residue

Titanium ˜63.6-73.3% mass, Chlorine ˜1.6-3.0% mass, Fluoride ˜0.6-trace mass, Oxygen was not quantified, but present.

The fluoride detected in Sample 1 is likely the result of fluoridation of the water (Oak Ridge, TN tap water used in this test). The fluoride in Sample 2 (DI water source) suggests mineralization of organic fluoride.

### Impact of AEC Residence Time on Performance

Test 2-8 was conducted to evaluate the effect of AEC module liquid feed residence time on performance. In this test the feed was operated at three rates (5, 10, and 35 mL/min). The operating voltage was varied to produce a constant electrical current in each test. All runs were conducted at the same initial feed conductivity of 491 uS/cm.

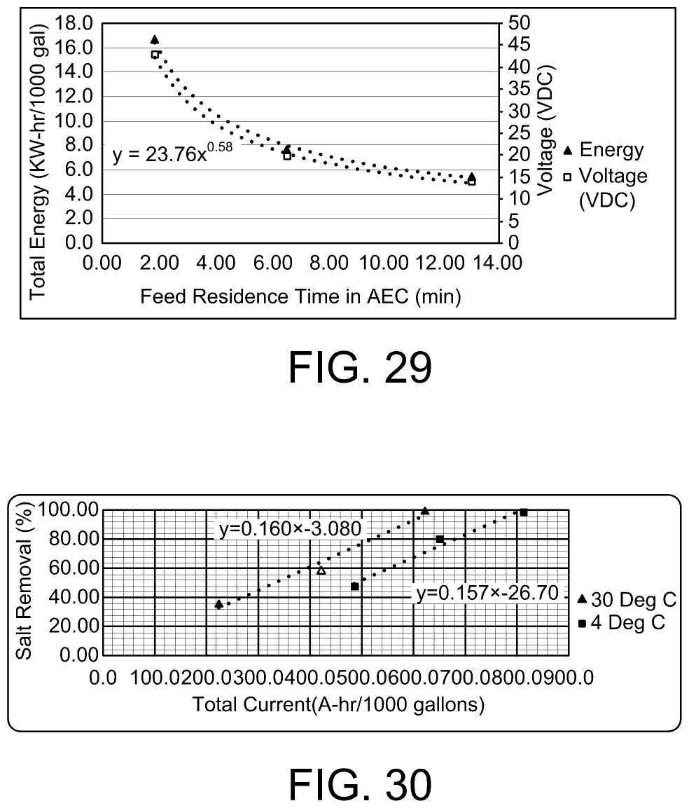

The results show that at a constant total current, salt removal was reasonably consistent (68.6 to 76 percent), with total PFOA and PFOS removal ranging from 45.2 to 55.7 percent. The energy required was inversely proportional to the square root of the residence time, as shown in FIG. 29, and the required voltage followed the same relationship.

In this test, at flow cross sectional dimensions of 8.525 mm×50.8 mm, or 4.33 cm², the flow rates are shown in Table 5-7 as superficial velocity (through empty area). The actual velocity through the chamber is estimated at 30% greater due to the presence of the feed chamber mesh spacer.

### 5.11 Temperature Effects

The effect of temperature on the removal of salt and PFOA and PFOS was evaluated in Tests 2-3 and 2-7. These two tests were conducted at the same two operating conditions and with an inlet feed salt concentration of 500 uS/cm. The results for salt are presented in FIG. 30. Equations fitting the results of each test are presented on the figure.

Because the trend lines are parallel, the required test current can be adjusted from a known reference current by subtracting 6.423 amps for every 1° C. temperature increase.

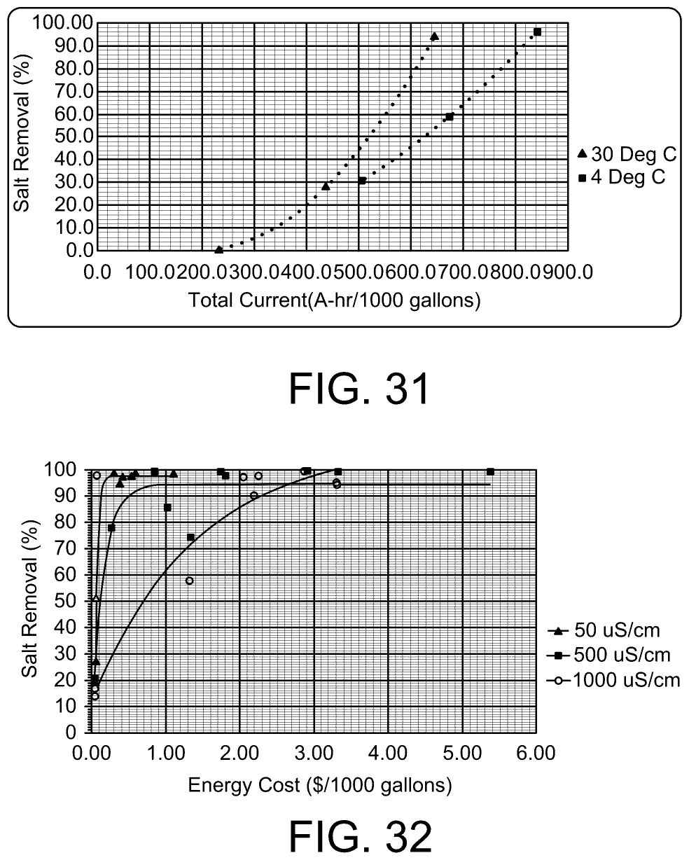

For total PFOA and PFOS evaluation of required current at different temperatures can be accomplished by interpolation from FIG. 31.

### Scale-Up Evaluation

### Economics of Phase I Bench Scale Testing

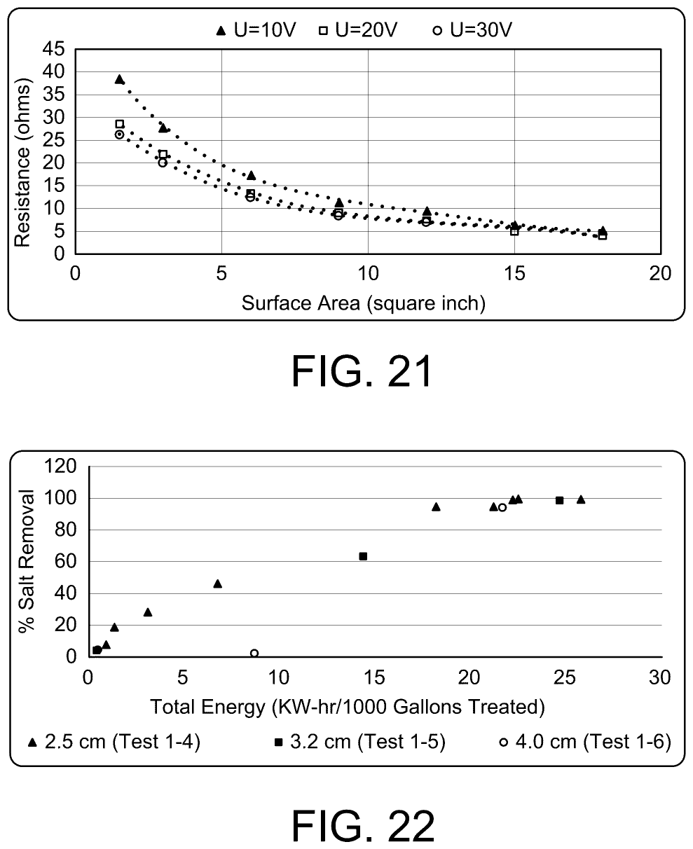

At the bench scale the initial primary indication of the AEC's suitability for commercialization is the cost of electrical power required to remove the PFAS. The bench scale AEC system was designed primarily to demonstrate PFAS removal, without considerable consideration of economic optimization. Some changes that will be made to the next level of AEC development will include modifications to promote better electrical efficiency and operational stability, and considerations previously discussed. These will include considerations including minimizing module thickness and associated internal separation distances. Chamber housings will likely be reduced from 5 mm to between 1-2 mm, with much thinner sealing gasket materials used. Additional electrical efficiency will be gained by incorporating a platinum plated anode, and possibly a gold-plated cathode, and utilizing information from FIG. 21 to minimize overall electrical resistance. For example, as noted in FIG. 21, increasing the module electrode area will result in a 2 times reduction in electrical resistance. Further module resistance reduction will be achieved by maintaining a relatively high side chamber (AEM/CEM) conductivity by increasing the feed to side chamber feed flow rate ratio.

In cost discussion it is important to note that the cost results are for a non-optimized system and should be viewed as order-of-magnitude costs. Due to optimization, electrical costs are expected to be lower in subsequent pilot generations of the AEC.

### Economics of Batch Operation

Energy costs are presented in FIG. 31 (salt removal) and FIG. 32 (PFOA and PFOS removal) for the Activity I batch testing. Energy costs are presented as a function of salt removal. Power cost was estimated at $0.0718/KW-hr based on July 2019 EIA data for industrial energy cost. On close observation the general trend can be observed. This chart shows that power costs are lower for water feed streams with low conductivities, and increase with increasing inlet feed conductivity. For example, at 50 uS/cm feed conductivity, the power cost for 98% salt removal is in the range of $0.40/1000 gallons, and for 500 uS/cm is $1.75. For 1000 uS/cm the same removal appears to fall around $3-4/1000 gallons as shown in FIG. 31.

FIG. 32 shows that energy costs for PFAS removal (initial concentration 100 ppb PFOA and 100 ppb PFOS) are lower when the feed stream conductivity is lower, and increase with increasing feed conductivity. For example, at 50 uS/cm feed conductivity, the cost for 98% PFAS removal is in the range of $0.30/1000 gallons, and for 500 uS/cm is $1.75. For 1000 uS/cm the same removal appears to fall around $3.00/1000 gallons.

### Flow Through Runs

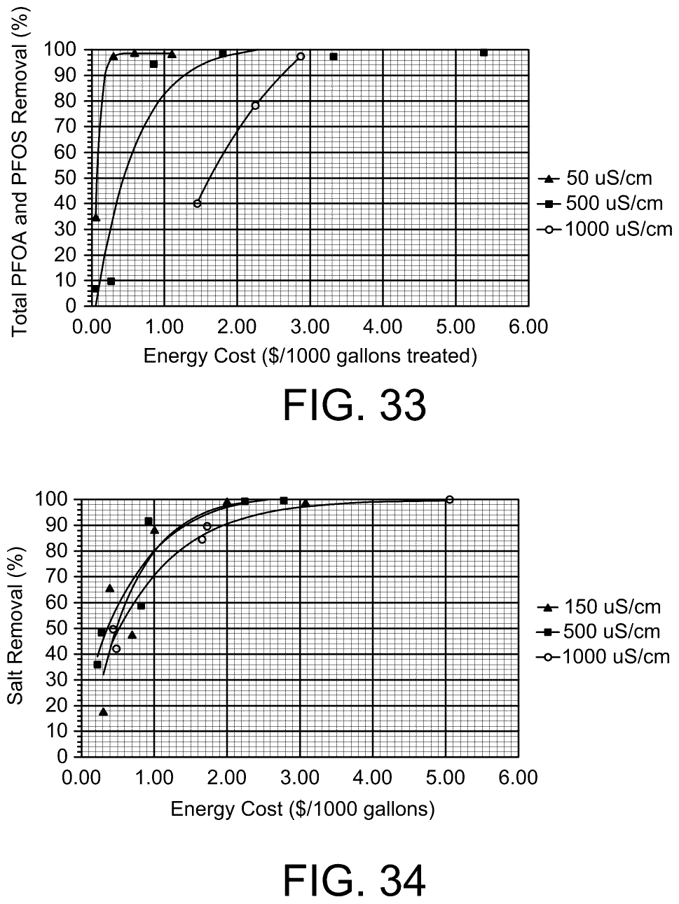

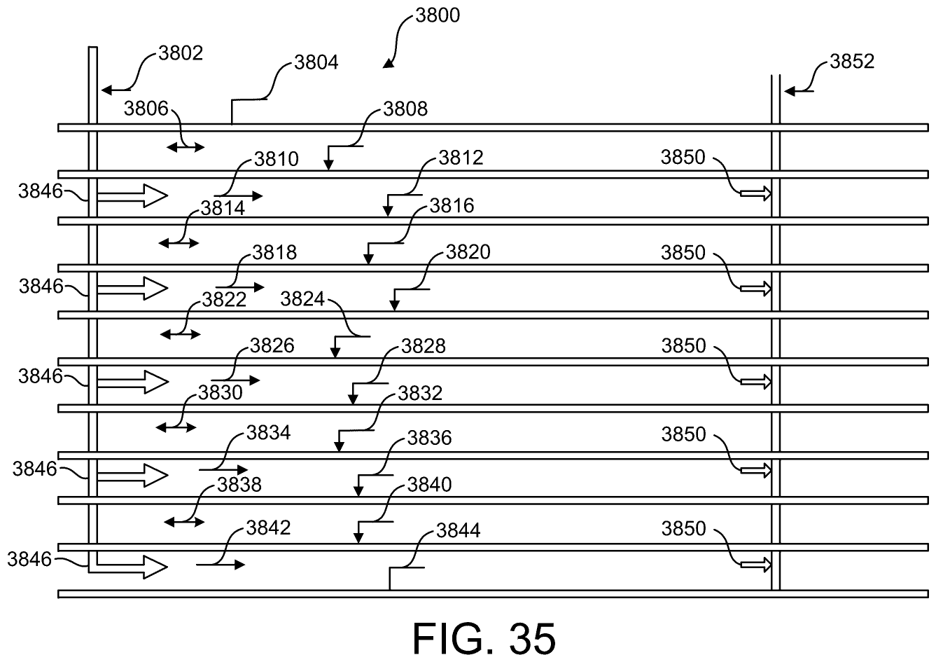

Energy costs for the flow-through AEC operating mode are presented in FIG. 33 (salt removal) and FIG. 35 (PFOA and PFOS removal), with costs presented as a function of percent removal. Energy cost was estimated at $0.0718/KW-hr. On close observation the general trend can be observed. This chart shows that power costs are lower for water feed streams with low conductivities, and increase with increasing feed conductivity. For example, at 150 uS/cm feed conductivity, the cost for 98% conductivity removal is in the range of $2.25/1000 gallons, and for 500 uS/cm is $3.00/1000 gallons. For 1,000 uS/cm the same removal appears to fall around $3.00/1000 gallons.

A semipermeable membrane (SPM) is a barrier that will only allow some molecules to pass through while blocking the passage of other molecules. A semipermeable barrier essentially acts as a filter. Different types of semipermeable membranes can block out different sized molecules. A semipermeable membrane can be made out of biological or synthetic material. The semipermeable membrane is defined by its pore size (to control the size of molecules allowed to pass through the SPM and its oleophilic/hydrophilic and ionic properties. Synthetic membrane can be fabricated from a large number of different materials. It can be made from organic or inorganic materials including solids such as metal or ceramic, homogeneous films (polymers), heterogeneous solids (polymeric mixes, mixed glasses), and liquids. Ceramic membranes are produced from inorganic materials such as aluminum oxides, silicon carbide, and zirconium oxide. Ceramic membranes are very resistant to the action of aggressive media (acids, strong solvents). They are very stable chemically, thermally, and mechanically, and biologically inert. Even though ceramic membranes have a high weight and substantial production costs, they are ecologically friendly and have long working life. Ceramic membranes are generally made as monolithic shapes of tubular capillaries.

### Polymeric Membranes

Polymeric membranes lead the membrane separation industry market because they are very competitive in performance and economics. Many polymers are available, but the choice of membrane polymer is not a trivial task. A polymer has to have appropriate characteristics for the intended application. The polymer sometimes has to offer a low binding affinity for separated molecules (as in the case of biotechnology applications), and has to withstand the harsh cleaning conditions. It has to be compatible with chosen membrane fabrication technology. The polymer has to be a suitable membrane former in terms of its chains rigidity, chain interactions, stereoregularity, and polarity of its functional groups. The polymers can form amorphous and semicrystalline structures (can also have different glass transition temperatures), affecting the membrane performance characteristics. The polymer may be obtainable and reasonably priced to comply with the low-cost criteria of membrane separation process. Many membrane polymers are grafted, custom-modified, or produced as co[polymers to improve their properties. The most common polymers in membrane synthesis are cellulose acetate, nitrocellulose and cellulose esters.(CN, and CE), polysulfone, polyether sulfone, polyacrylonitrile, polyamide, polyimide, polyalkylene (polyethyelene and polypropylene), polytetrafluoroethylene, polyvinylidenefluoride and polyvinyl chloride, as well as copolymers of these materials.

Polymer membranes may be functionalized into ion exchange membranes by the addition of highly acidic or basic functional groups, e.g. sulfonic acid and quaternary ammonium, enabling the membrane to form water channels and selectively transport cations or anions, respectively. The most important functional materials in this category include proton exchange and alkaline anion exchange membranes, that are at the heart of many technologies in water treatment, energy storage, energy generation. Applications within water treatment include reverse osmosis, electrodialysis, and reversed electrodialysis

### Ceramic Membranes

Ceramic membranes are made from inorganic materials (such as alumina, titania, and zirconia oxides, recrystallized silicon carbide or some glassy materials). By contrast with polymeric membranes, they can be used in separations where aggressive media (acids, strong solvents) are present. They also have excellent thermal stability which make them usable in high temperature membrane operations.

For purposes of explaining aspects of the invention, a basic unit called a cell is defined as two electrodes (an anode and a cathode) enclosing at least one set of membranes (an anodic semipermeable membrane and a cathodic semipermeable membrane), the at least one set of membranes typically being separated by a liquid permeable gasket (alternatively defined as a separator). The basic unit may be expanded with additional sets of membranes (and spacers) between the two electrodes. This would result in a multiple cell structure such as Anode, 1^{st} liquid permeable gasket, 1^{st} anodic membrane, 2^{nd} liquid permeable gasket, 1^{st} cathodic membrane, 3^{rd} liquid permeable gasket, 2^{nd} anodic semipermeable membrane, 4^{th} liquid permeable gasket, 3^{rd} cathodic semipermeable membrane, etc. repeating to the Cathode. This would create a series of cells working in parallel. Alternatively, the cells may operate in series, with exiting mediated contaminated liquid flow from a single set (single set of anodic and cathodic membranes) cell passing into a subsequent single set cell. The following description explains how the cells and cell systems can be operated to achieve immediately potable streams of mediated water from contaminated aqueous feed streams. The cell would be first charged with potable water, so that subsequently added contaminated streams would benefit by complete cell treatment before exiting. When the cell or cell system is first charged with only contaminated aqueous feed, the feed would fill the cell along the entire flow path, to the exit port, without being mediated. First portions of exiting liquid would therefore not have been effectively mediated, and likely would have to be recycled or separately handled until exiting liquids have been treated along the entire flow path. This process is simplified by first charging the entire cell with potable water before introducing a contaminated aqueous stream.

Reference to FIG. 35 will assist in further understanding of the operation of the systems of the present invention. The internal operation of a multicell system 3800 is shown with a contaminated aqueous feed 3802 passing through a first anode 3804, then a first gasket 3808 (all gaskets referenced in this paragraph are aqueous permeable gaskets), then an anodic semipermeable membrane 3812, then through a second gasket 3816, then through a cathodic semipermeable membrane 3820, then through another gasket 3824, then a second anodic semipermeable membrane 3828, then yet another gasket 3832, a second cathodic semipermeable membrane 3836, then a last gasket 3840, ending with the end of the introduced flow 3842 against the cathode 3844. All contaminated fluid enters along entry ports 3846 into volumes of space including 3810, 3818, 3826, 3834, and 3842, and includes flow into the gaskets 3808, 3824, and 3840. The flow into those three gaskets and against the anodic semipermeable membranes 3812, and 3828 results in originating contaminated streams 3810, 3818, 3826, 3834, and 3841 exiting the cells into capture exit portals 3850 and out of exit port 3852 as a PFAS mediated stream. Anionic contaminates and cationic contaminants are respectively captured by the anodic and cathodic semipermeable membranes.

As stated above, by filling all (or most) available volume in the cell system before adding PFAS-contaminated aqueous feed, essentially all exiting mediated flow can be potable. If the contamination levels are extremely high, one or more subsequent passes may be needed, with the exit stream 3850 being sent into another cell unit. The high efficiency of these cells seldom if ever require more than one pass, and never require more than two passes through the same or serial cell systems to achieve potability.

It must be understood that the perspectives, relative dimensions and views within FIG. 35 are not to be considered limiting. By way of a non-limiting explanation, all activity and elements in 3806, 3808, and 3810 may occur within a single volume, essentially determined by the dimensions of the open mesh of spacer or gasket 3808, with additional volume created by liquid flowing over both surfaces of the gasket. That dimension may be as small as about 1/16^{th} inches (0.246 mm) to 5/16^{th} inches (1.23 mm). Smaller dimensions are not practicable, as the flow rate would be too slow, but in small personal mediating systems, a lower limit of 3/64^{th} inches (0.184 mm) could be tolerated. Larger dimensions can be used with diminishing cell efficiency, with about 0.5 inches (1.27 cm) being a likely maximum tolerable reduction in efficiency. The gasket is an open structure, allowing free flow of liquid throughout its defining volume. It may be rigid flexible or compressible, but should retain its volume during use. The surrounding cell elements (e.g., electrodes, semipermeable membranes, housing shell) should not compress the gasket or mesh to an extent that would reduce flow volume through it by more than 75%, preferably not more than 50%.

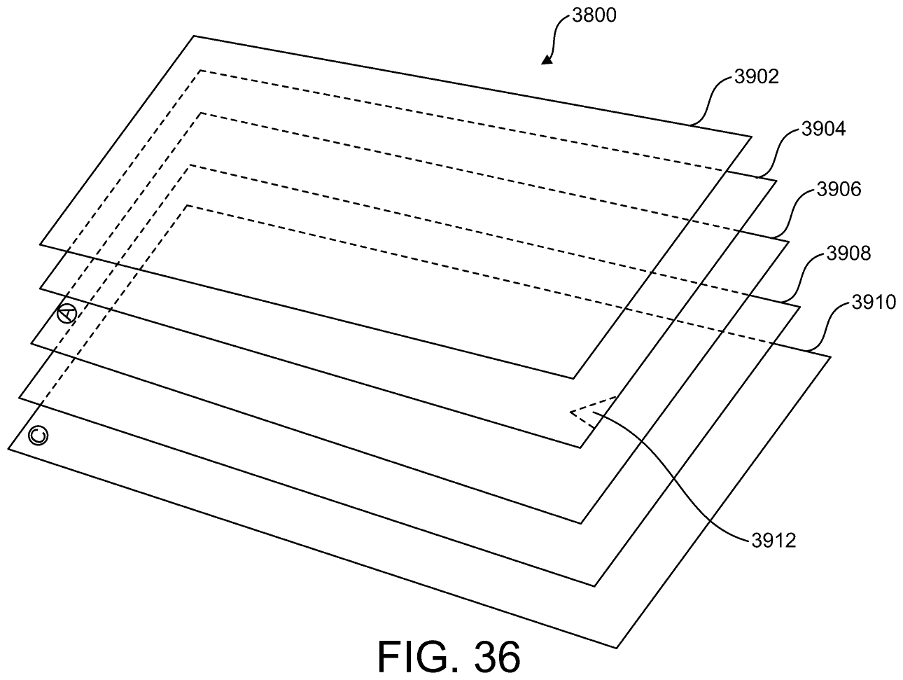

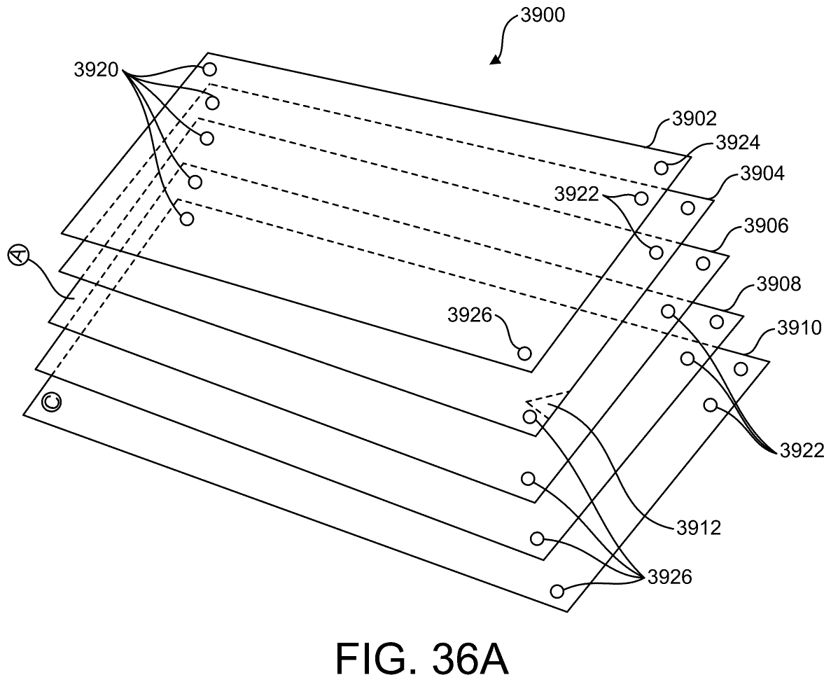

FIG. 36 shows a perspective exploded view of a single cell content 3900. The anode 3900 is shown displaced over the first gasket 3904, which in turn is adjacent an anodic semipermeable membrane 3906. Note the marking of “A” on an edge of the anionic membrane. That mark, or any other visually distinguishing mark a colored strip, unique beveling or cut in an edge, has been done to distinguish the anionic semipermeable membrane 3906 from the cationic semipermeable membrane 3910 within the single cell content 3900. As replacement of exhausted membranes (or dirty membranes that will be cleaned and regenerated for reuse) will be done by hand periodically (approximately semiannually with expected volumes of use), it is critical that the correct membranes be placed in their required specific order for the system to operate effectively. Below the anionic semipermeable membrane 3906 is another gasket 3908 and then the cationic semipermeable membrane 3910. The last membrane in the single cell is also shown with a definitive visually observable marking (in this case a “C”) to add additional visual distinction to the set of semipermeable membranes. Other visual markings may also be used here. There would be a cathode (not shown) below the cationic semipermeable membrane 3910.

Replacement of the exhausted Cell unit is currently done by removing each layer in sequence (3902, 3904, 3906, 3908, and 3910). The new equivalent layers would then be replaced in reverse order, 3910, 3908, 3906, 3904 and the original 3901 if it had not been affected by use. The markings help assure that the replenishment has increased protection against error. It is further likely that in the future, a complete cell replacement unit can be used, a structure comprising all of layers 3910, 3908, 3906, 3904 in that order. An additional gasket (not shown) would be attached to (below) the cathodic semipermeable membrane 3910 so that it would be adjacent the next cell unit (not shown) or the cathode (not shown). In that case, the visual markings on the semipermeable membranes might not be exposed. To assure required positioning of the cell replacement unit, a more physical replacement unit should be provided such as an eccentrically located cut out 3912 (in all layers, with a corresponding post being a male match for the cutout) that will allow the cell unit installation in only a single orientation in the housing, requiring all layers to be in the correct order for the system to operate.

In current constructions, bolts are used to secure the cells into a housing. The bolt holes in the anode, cathode and housing may also be eccentrically oriented about the cell housing replacement unit matching eccentricity in the anode, cathode and housing. In this way also, only a uniquely oriented replacement cell (or multiple replacement cells) can be used to replace the exhausted cell (or multiple cells). This structural modification can reduce the significant potential for misplacement of replacements in the system.

FIG. 36A shows a perspective exploded view of the single cell content of FIG. 39 with an alternative or additional alignment function. The same numbers in FIG. 36A represent identical elements in FIG. 36. Currently the cell units are secured into a housing with bolts passing through all cell unit layers. To assure proper alignment and orientation of the semipermeable membranes, illustratively three separate sets of excentric bolt holes 3922 3924 3926 are shown on one side of the exploded cell unit 3900, and a single set of bolt holes 3920 is shown on the opposite side of the cell unit. No matter how the cell unit is oriented, the holes will align with a compatible pattern in the housing with only a single orientation. It is therefore impossible to insert the unit into the housing with the semipermeable membranes misaligned. Other unit configurations and cell unit shapes may also be used to prevent misorientation. For example, the overall shape of the cell unit may be an excentric truncated pyramidal shape, such that the geometric shape of the cell unit van be inserted into the housing in only one configuration, again forcing the linear orientation of elements within the cell unit to present the semipermeable membranes in the correct and required order.

The structures and improvements of FIGS. 35, 36 and 36A are specified as useful in combination with each of the attractants attached to the anionic semipermeable membranes with any cationic semipermeable membrane.

Other variations in the practice of the technology can be exercised using the teachings provided herein.

What is claimed:

1. A system for the removal of poly- and/or perfluoroalkyl fluorinated material contaminants from an aqueous mass, wherein the system comprises:
a) a first chamber for holding the aqueous mass containing a detectable amount of poly- and/or perfluoroalkyl fluorinated materials;
b) an anode and a cathode in electronic connection with the aqueous mass in the first chamber;
c) an anionic poly- and/or perfluoroalkyl fluorinated material contaminant retaining sheet between the aqueous mass and the anode; and
d) a cationic contaminant material retaining sheet between the aqueous mass and the cathode;
wherein the anionic poly- and/or perfluoroalkyl fluorinated material contaminant retaining sheet comprises at least 0.0001% by total weight of the anionic poly- and/or perfluoroalkyl fluorinated material contaminant retaining sheet of a cationic material or a proteinaceous material adhered to the anionic semipermeable membrane.

2. The system of claim 1 further comprising a spacer within the first chamber through which the aqueous mass flows.

3. The system of claim 2 wherein the spacer comprises a mesh having a thickness of from 30 μm to 5 mm between the anionic poly- and/or perfluoroalkyl fluorinated material contaminant retaining sheet and the cationic poly- and/or perfluoroalkyl fluorinated material contaminant retaining sheet.

4. The system of claim 1 wherein the cationic material is adhered to the anionic semipermeable membrane comprises a compound having a cation selected from the group consisting of quaternary and ammonium cations, sulfonium cations, phosphonium cations, iodonium cations, and boronium cations.

5. The system of claim 3 wherein the anionic poly- and/or perfluoroalkyl fluorinated material contaminant retaining sheet comprises at least 0.001% by total weight of the anionic poly- and/or perfluoroalkyl fluorinated material contaminant retaining sheet of a cationic quaternary ammonium compound adhered to the anionic poly- and/or perfluoroalkyl fluorinated material contaminant retaining sheet.

6. The system of claim 3 wherein the cationic material comprises a polymer adhered to the anionic poly- and/or perfluoroalkyl fluorinated material contaminant retaining sheet.

7. The system of claim 3 wherein the cationic material comprises a quaternary ammonium polymer.

8. The system of claim 2 wherein the spacer has a thickness between 20 μm to 5 mm.

9. The system of claim 1 wherein the proteinaceous material is present on the anionic poly- and/or perfluoroalkyl fluorinated material contaminant retaining sheet between the aqueous mass and the anode.

10. The system of claim 2 wherein the anionic poly- and/or perfluoroalkyl fluorinated material contaminant retaining sheet has a thickness between 30 μm and 2 mm.

11. The system of claim 3 wherein there are position-sensitive markings, holes, color markings, indentations or cuts on one or more of three layers comprising the spacer, the anionic poly- and/or perfluoroalkyl fluorinated material contaminant retaining sheet, and the cationic retaining sheet such that the three layers can be positioned within a housing with only one alignment of the three layers within the housing when the position-sensitive markings, holes, color markings, indentations or cuts are visually and/or physically aligned.

13. The system of claim 12 wherein the three layers comprising the spacer, the anionic poly- and/or perfluoroalkyl fluorinated material contaminant retaining sheet, and the cationic retaining sheet are secured together by mechanical connectors or chemical bonding and the position-sensitive markings, holes, color markings, indentations or cuts are visually and/or physically aligned across the three layers.

14. A method for extracting poly- and/or perfluoroalkyl fluorinated materials from a contaminated aqueous medium comprising:
providing a system for the removal of poly- and/or perfluoroalkyl fluorinated material contaminants from an aqueous mass, wherein the system comprises: a) a first chamber for holding the aqueous mass containing a detectable amount of poly- and/or perfluoroalkyl fluorinated materials; b) an anode and a cathode in electronic connection with the aqueous mass in the first chamber; c) an anionic poly- and/or perfluoroalkyl fluorinated material contaminant retaining sheet between the aqueous mass and the anode; and d) a cationic contaminant material retaining sheet between the aqueous mass and the cathode; d) wherein the anionic poly- and/or perfluoroalkyl fluorinated material contaminant retaining sheet comprises at least 0.0001% by total weight of the anionic poly- and/or perfluoroalkyl fluorinated material contaminant retaining sheet of a cationic material or a proteinaceous material adhered to the anionic semipermeable membrane within a housing with a feed liquid comprising an aqueous medium contaminated with poly- and/or perfluoroalkyl fluorinated materials within a chamber;
wherein the method comprises:
i. applying a current between the anode and cathode to attract the poly- and/or perfluoroalkyl fluorinated materials towards the anode and onto the anionic semipermeable membrane; and
ii. the anionic poly- and/or perfluoroalkyl fluorinated material contaminant retaining sheet retaining poly- and/or perfluoroalkyl fluorinated materials thereon.

15. The method of claim 14 wherein multiple systems treat the contaminated aqueous medium in a parallel arrangement of the multiple systems.

16. The method of claim 14 wherein multiple systems treat the contaminated aqueous medium in a series arrangement of the multiple systems

17. The method of claim 14 wherein the system further comprising a spacer within the first chamber through which the aqueous mass flows.

18. The method of claim 17 wherein the spacer comprises a mesh having a thickness of from 30 μm to 5 mm between the anionic poly- and/or perfluoroalkyl fluorinated material contaminant retaining sheet and the cationic poly- and/or perfluoroalkyl fluorinated material contaminant retaining sheet.

19. The method of claim 17 wherein the cationic material is adhered to the anionic semipermeable membrane comprises a compound having a cation selected from the group consisting of quaternary and ammonium cations, sulfonium cations, phosphonium cations, iodonium cations, and boronium cations.

20. The method of claim 19 wherein the anionic poly- and/or perfluoroalkyl fluorinated material contaminant retaining sheet has a thickness between 30 μm and 2 mm.
